(19) United States
(12) Patent Application Publication
(10) Pub. No.: US 2026/0236585 A1
(43) Pub. Date: Aug. 13, 2026

(54) PROTECTING BOOT LOGICAL UNIT CONFIGURATIONS USING AN AUTHENTICATION-KEY-PROTECTED PORTION OF A MEMORY SYSTEM

(71) Applicant: Micron Technology, Inc., Boise, ID (US)

(72) Inventors: Binbin HUO, Sauerlach (DE); Tommaso ZERILLI, Muenchen (DE); Christian M. GYLLENSKOG, Meridian, ID (US)

(21) Appl. No.: 19/450,793

(22) Filed: Jan. 16, 2026

Related U.S. Application Data
(60) Provisional application No. 63/757,445, filed on Feb. 12, 2025.

(51) Int. Cl. G06F 21/57; G06F 9/445

(52) U.S. Cl. CPC G06F 21/575; G06F 9/44505; G06F 2221/034

(57) ABSTRACT

In some implementations, a memory system may receive a request to access one of a boot logical unit (LU) switch configuration associated with the memory system or a boot LU write protection configuration associated with the memory system, where the one of the boot LU switch configuration or the boot LU write protection configuration is protected by an authentication-key-protected portion of the memory system. The memory system may determine whether the request is authenticated based on an authentication key and/or a message authentication code associated with the request. The memory system may allow the request to access the one of the boot LU switch configuration or the boot LU write protection configuration based on determining that the request is authenticated, or deny the request to access the one of the boot LU switch configuration or the boot LU write protection configuration based on determining that the request is not authenticated.

### CROSS-REFERENCE TO RELATED APPLICATION

This Patent Application claims priority to U.S. Provisional Patent Application No. 63/757,445, filed on February 12, 2025, entitled “PROTECTING BOOT LOGICAL UNIT CONFIGURATIONS USING AN AUTHENTICATION-KEY-PROTECTED PORTION OF A MEMORY SYSTEM,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to protecting boot logical unit configurations using an authentication-key-protected portion of a memory system.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a universal flash storage (UFS) specification, and thus may be referred to as a UFS compliant memory device and/or a UFS compliant memory system, or, more simply, a UFS device.

### BRIEF DESCRIPTION OF THE DRAWINGS

FIG. 1 is a diagram illustrating an example system capable of protecting boot logical unit (LU) configurations using an authentication-key-protected portion of a memory system.

FIG. 2 is a diagram of another example capable of protecting boot LU configurations using an authentication-key-protected portion of a memory system.

FIG. 3 is a diagram of an example associated with an unauthenticated access of a boot LU configuration.

FIG. 4 is a diagram of an example of protecting a boot LU configuration using a secure configuration protect block of an authentication-key-protected portion of a memory system.

FIG. 5 is a diagram of an example of protecting a boot LU configuration using a secure write protect configuration block of an authentication-key-protected portion of a memory system.

FIG. 6 is a diagram of an example process associated with protecting a boot LU switch configuration using an authentication-key-protected portion of a memory system.

FIG. 7 is a diagram of an example process associated with a memory system determining which of multiple candidate boot LUs is an active boot LU and mapping the active boot LU to a boot well known LU.

FIGS. 8A-8D are diagrams of examples associated with authenticated read and write operations for boot LU configurations that are protected using an authentication-key-protected portion of a memory system.

FIGS. 9A-9B are examples associated with protecting boot LU configurations using an authentication-key-protected portion of a memory system.

FIG. 10 is a flowchart of an example method associated with protecting boot LU configurations using an authentication-key-protected portion of a memory system.

### DETAILED DESCRIPTION

Universal flash storage (UFS) is a common form of data storage utilized in various electronic devices, offering high data transfer speeds and increased reliability. However, the current UFS specifications lack robust authentication mechanisms to secure access to boot logical units (LUs) and their configurations. This may create a vulnerability, as unauthorized access and modification of boot LU configurations may result in malicious software updates and compromise device security.

Some techniques and implementations described herein enable secure access to boot LU configurations in a memory system. In some implementations, a memory system (e.g., a UFS compliant memory system and/or UFS device) may store boot LU configurations in an authentication-key-protected portion of the memory system, such as a replay-protected memory block (RPMB) of a UFS device. In such implementations, the memory system may authenticate requests to access boot LU configurations, such as by determining if the request is authenticated based on an authentication key or a message authentication code (MAC) associated with the request. Accordingly, the memory system may allow access to the boot LU configurations when the access request is authenticated, and/or may deny access to the boot LU configurations when the access request is not authenticated.

In this way, the techniques and implementations described herein ensure that only authenticated requests can be used to modify boot LU configurations, enhancing the overall security of the memory system. Accordingly, the techniques and implementations described herein may conserve processing and memory resources by preventing unauthorized access and potential corruption of boot sequences as well as contribute to the improvement of system integrity and stability. In some implementations, the techniques described herein may provide enhanced security for UFS storage applications within the automotive industry, where reliable and secure boot operations may be critical. Overall, the techniques and implementations described herein improve the quality and reliability of UFS compliant memory devices.

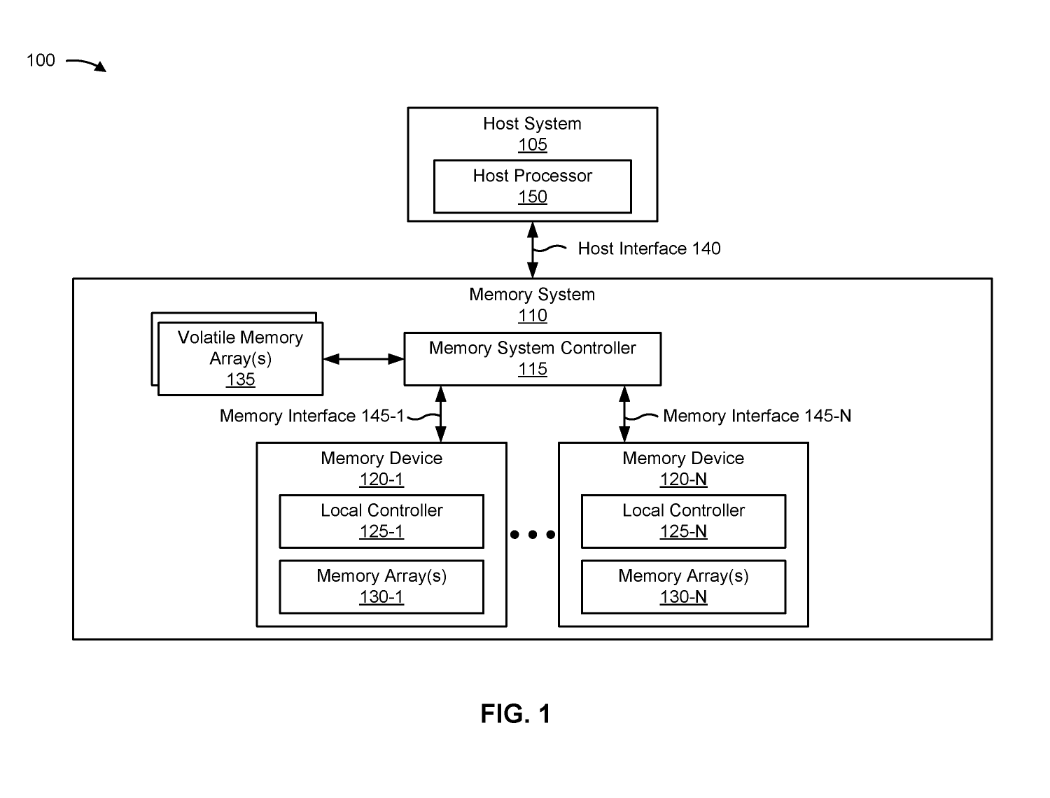

FIG. 1 is a diagram illustrating an example system 100 capable of protecting boot LU configurations using an authentication-key-protected portion of a memory system. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N ≥ 1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N ≥ 1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a compute express link (CXL) memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, a CXL controller connected to DRAM, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a UFS interface, an eMMC interface, a double data rate (DDR) interface, a DIMM interface, and/or a CXL interface (e.g., a PCIe/CXL interfaces).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to receive a request to access one of a boot LU switch configuration associated with the memory system or a boot LU write protection configuration associated with the memory system, wherein the one of the boot LU switch configuration or the boot LU write protection configuration is protected by an authentication-key-protected portion of the memory system; determine whether the request is authenticated based on at least one of an authentication key or a MAC associated with the request; and one of: allow the request to access the one of the boot LU switch configuration or the boot LU write protection configuration based on determining that the request is authenticated, or deny the request to access the one of the boot LU switch configuration or the boot LU write protection configuration based on determining that the request is not authenticated.

In some implementations, one or more systems, devices, apparatuses, components, and/or controllers of FIG. 1 may be configured to receive a request to access one of a boot LU switch configuration associated with the UFS compliant device or a boot LU write protection configuration associated with the UFS compliant device, wherein the one of the boot LU switch configuration or the boot LU write protection configuration is protected by a RPMB of the UFS compliant device; determine whether the request is authenticated based on at least one of an authentication key or a MAC associated with the request; and one of: allow the request to access the one of the boot LU switch configuration or the boot LU write protection configuration based on determining that the request is authenticated, or deny the request to access the one of the boot LU switch configuration or the boot LU write protection configuration based on determining that the request is not authenticated.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

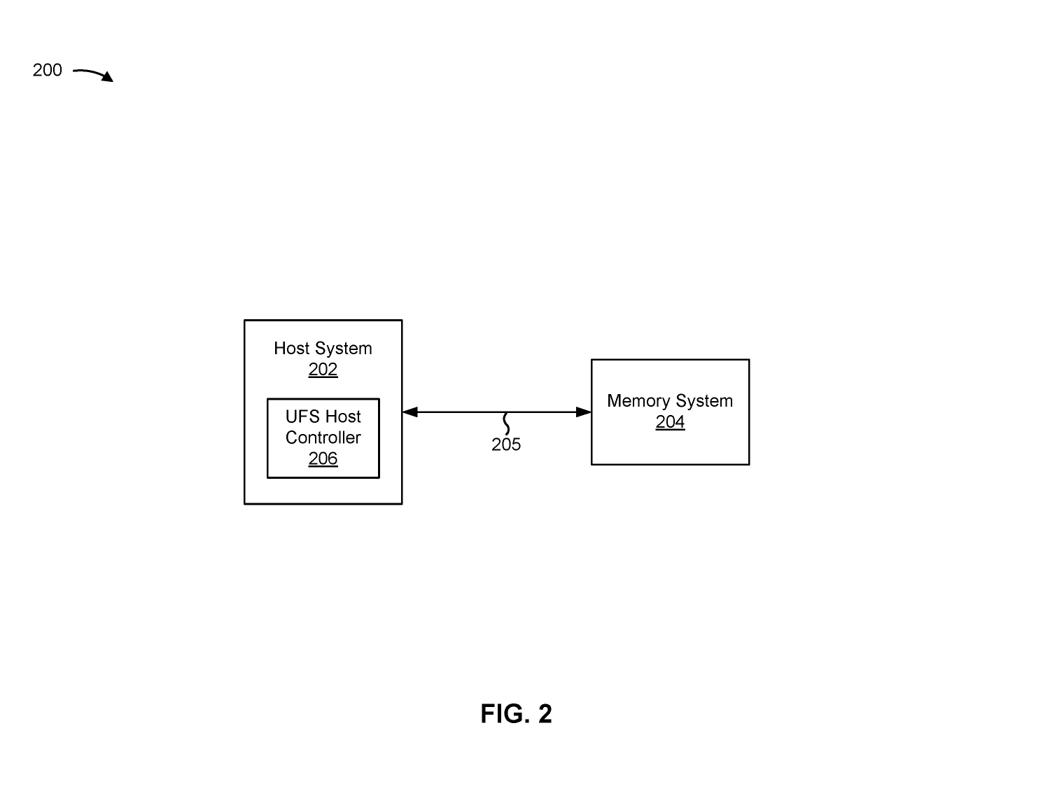

FIG. 2 is a diagram of another example 200 capable of protecting boot LU configurations using an authentication-key-protected portion of a memory system. The example 200 may be associated with UFS. UFS is a specification for non-volatile memory. UFS was developed by the Joint Electron Device Engineering Council (JEDEC) solid state technology association. UFS may be utilized in a variety of electronic devices, such as smart phones, tablets, digital cameras, automotive applications, and/or other types of embedded systems. UFS may offer a high-performance and efficient storage solution. UFS may provide high-speed data transfer capabilities, which may be useful for high-resolution video recording, fast application loading, and/or quick data transfers. UFS may support simultaneous read and write operations, known as full duplex, which may enhance a multitasking performance. UFS may be power-efficient, which may be beneficial for mobile devices, automotive applications, and similar applications. UFS may utilize a command queue, allowing for multiple commands to be processed in parallel, which may improve overall efficiency and performance. The command queue may reduce power usage during data processing.

As shown in FIG. 2, a host system 202 (e.g., host system 105), such as a UFS host, may communicate with a memory system 204 (e.g., memory system 110), such as a UFS memory system and/or UFS device. The host system 202 may be associated with an application processor or a system on chip (SoC), for example. The memory system 204 may include a controller and non-volatile memory, such as flash memory. The host system 202 may communicate with the memory system 204 via an interconnect 205 (e.g., host interface 140). The interconnect 205 may utilize a high-speed interface to allow for rapid data transfer between the host system 202 and the memory system 204.

In some examples, the host system 202 may include a UFS host controller 206 (e.g., the application processor and/or SoC of the host system 202 may include the UFS host controller 206). The UFS host controller 206 may be a hardware component of the host system 202 that manages communication between the host system 202 and the memory system 204 (e.g., the UFS device), such as via a UFS host controller interface (UFSHCI) (e.g., a standard interface defined by JEDEC). In some examples, the UFS host controller 206 may be responsible for interpreting commands, managing data transfers, ensuring efficient and reliable interactions with the UFS device, and/or performing similar tasks. More particularly, the UFS host controller 206 may perform command processing tasks (e.g., tasks associated with interpreting and managing commands from the host system 202 to the memory system 204, such as read, write, and/or erase operations), data transfer management tasks (e.g., tasks associated with data transfer between the host system 202 and the memory system 204, such as data transfer via high-speed interfaces like mobile industry processor interface (MIPI) M-PHY and unified protocol (UniPro), among other examples), power management tasks, error checking and correction tasks, and/or similar tasks. In some examples, the UFS host controller 206 may be part of an SoC in mobile and embedded systems.

As indicated above, FIG. 2 is provided as an example. Other examples may differ from what is described with regard to FIG. 2.

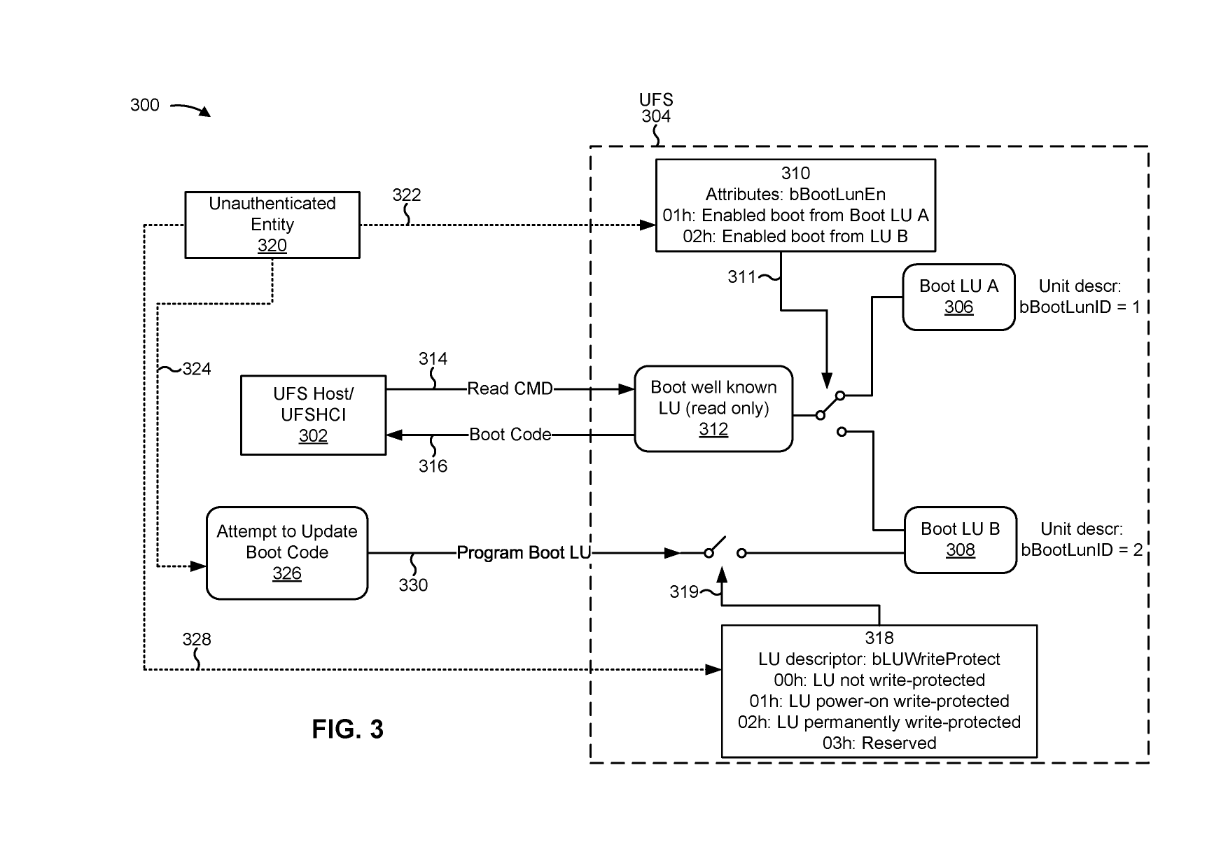

FIG. 3 is a diagram of an example 300 associated with an unauthenticated access of a boot LU configuration.

In some examples, a memory system (e.g., a UFS memory system and/or UFS device, such as memory system 204), may be associated with two boot LUs, such as a first boot LU indexed as “boot LU A” and a second boot LU indexed as “boot LU B.” A boot LU is a designated area of non-volatile memory (e.g., within a UFS device) that is specifically used for storing boot-related information and files. In some examples, a boot LU may be used for the initialization and start-up processes of a memory system, such as loading the operating system (OS) of the memory system or other essential software components. In some examples, boot LUs may be configured to provide the necessary speed and reliability required during the boot process, ensuring that a device can boot up quickly and efficiently. Typically, UFS devices may have multiple boot LUs (e.g., boot LU A and boot LU B) to facilitate dual-boot configurations or other advanced boot mechanisms. For example, using two boot LUs may ensure redundancy in the memory system, because boot LU B may be accessed if there is an error or failure at boot LU A, and vice versa. Additionally, or alternatively, two boot LUs may be utilized for a purpose of upgrading boot code, because a UFS host (e.g., host system 202) may update boot code to an inactive boot LU, then later switch to the updated boot LU.

More particularly, in the example 300, a UFS host 302 (e.g., host system 202) may be in communication with a UFS device 304 (e.g., memory system 204) that is associated with two boot LUs, including a first boot LU 306 (e.g., boot LU A) and a second boot LU 308 (e.g., boot LU B). Each boot LU 306, 308 may be associated with a corresponding boot LU number (LUN) identifier (ID), sometimes referred to herein as bBootLunID. For example, as shown in FIG. 3, the first boot LU 306 may be associated with a bBootLunID 1 and the second boot LU 308 may be associated with a bBootLunID 2. Moreover, the UFS device 304 may be associated with certain LU configurations, attributes, descriptors, and/or similar parameters indicating which boot LU is to be accessed upon powering on the UFS device 304 and/or whether or not the boot LUs may be edited by the UFS host 302 and/or another device.

For example, as indicated by reference number 310, the UFS device 304 may be associated with a boot LU enable configuration, sometimes referred to herein as bBootLunEn. The boot LU enable configuration is an attribute that indicates which of the two boot LUs (e.g., the first boot LU 306 or the second boot LU 308) is enabled as the boot LU, and thus the boot LU enable configuration enables the UFS host 302 to enable or disable specific boot LUs on the UFS device 304. In some examples, setting the boot LU enable configuration to 00h is used to indicate that no boot LU is enabled, setting the boot LU enable configuration to 01h is used to indicate that boot LU A (e.g., the first boot LU 306) is enabled, and/or setting the boot LU enable configuration to 02h is used to indicate that boot LU B (e.g., the second boot LU 308) is enabled. As depicted in FIG. 3 using a switch indicated by the arrow labeled with reference number 311, the boot LU enable configuration in this example 300 may be set to 01h, indicating that the first boot LU 306 is to be used during the boot process. In some examples, the boot LU indicated by the boot LU enable configuration may be mapped as a boot well known LU (sometimes referred to herein as W_BootLU), as indicated by reference number 312. In such examples, the boot well known LU may be a read-only boot LU accessible by the UFS host 302 during boot up of the UFS device 304. For example, upon startup of the UFS device 304, the UFS host 302 may transmit, to the UFS device 304, a read command (as indicated by reference number 314) associated with the boot well known LU, and the UFS device 304 may thus transmit, to the UFS host 302, boot code and/or other boot information indicated by the boot well known LU (as indicated by reference number 316).

Additionally, or alternatively, as indicated by reference number 318, the UFS device 304 may be associated with a boot LU write protect configuration, sometimes referred to herein as bLUWriteProtect. The boot LU write protect configuration is an attribute that controls a write protection status of the boot LUs 306, 308, such as by indicating whether or not data on the boot LUs 306, 308 can be written to. Put another way, in some examples boot areas (e.g., boot LUs) may be protected in order to avoid boot code alteration by a third party, with the write protection mechanism for the boot LUs being defined by configuring the corresponding bLUWriteProtect parameter. In some examples, setting the boot LU write protect configuration to 00h is used to indicate that a boot LU is not write-protected, setting the boot LU write protect configuration to 01h is used to indicate that the boot LU is power-on write-protected (e.g., the boot LU is write-protected until the UFS device 304 undergoes a power cycle, such that turning the UFS device 304 off and on again will reset the write protection status), and/or setting the boot LU write protect configuration to 02h is used to indicate that the boot LU is permanently write-protected (e.g., the boot LU is permanently write-protected and cannot be written to even after a power cycle). Other codepoints, such as 03h, may be reserved. As depicted in FIG. 3 using an open switch indicated by the arrow labeled with reference number 319, the boot LU write protect configuration in example 300 may be set to one of 01h or 02h, indicating that the second boot LU 308 is write-protected and thus cannot be programmed by the UFS host 302 or other device.

However, while one or more of the boot LU configurations described above may provide write protection mechanisms (such as permanent and/or power-on write protection) for a boot LU, the configurations do not include any access authentication mechanisms, such as for a purpose of preventing unauthorized access to the boot LU. For example, no authentication is required for boot LU switching (e.g., no authentication is required for accessing and/or updating the boot LU enable configuration (e.g., bBootLunEn)) and/or for configuring a boot LU write protection (e.g., no authentication is required for accessing and/or updating the boot LU write protect configuration (e.g., bLUWriteProtect)). Accordingly, in some examples, an unauthorized entity may perform a boot LU switch and/or update boot code, among other examples.

More particularly, as shown in FIG. 3, in some examples an unauthenticated entity 320 may be capable of switching between boot LUs, such as by writing to the boot LU enable configuration (e.g., bBootLunEn) and/or updating the boot LU enable configuration, as indicated using the broken-line arrow labeled with reference number 322. For example, if boot LU enable configuration is initially set to 01h, indicating that the first boot LU 306 is enabled (in a similar manner as described above), the unauthenticated entity 320 may update the boot LU enable configuration to 00h such that no boot LU is enabled, or else may update the boot LU enable configuration to 02h such that the second boot LU 308 is enabled. Moreover, as shown using the broken-line arrow labeled with reference number 324, the unauthenticated entity 320 may attempt to update boot code associated with the second boot LU 308, as indicated by reference number 326. However, if the boot LU write protection configuration (e.g., bLUWriteProtect) is set to one of 01h or 02h, indicating that the second boot LU is write-protected (in a similar manner as described above), the unauthenticated entity 320 may be prevented from doing so.

However, as indicated by the broken-line arrow labeled with reference number 328, the unauthenticated entity 320 may be capable of removing the write protection, such as by updating the boot LU write configuration and/or updating the boot LU enable configuration. For example, if the boot LU write protect configuration is initially set to 01h or 02h, indicating that the second boot LU 308 is write-protected, the unauthenticated entity 320 may update the boot LU write configuration to 00h such that no write protection is enabled. In such examples, the unauthenticated entity 320 may then be able to program the second boot LU 308, as indicated by reference number 330.

In this way, without proper authentication of requests to update the boot LU enable configuration (e.g., bBootLunEn) and/or the boot LU write protect configuration (e.g., bLUWriteProtect), the UFS device 304 may be vulnerable to malicious boot code updates (e.g., attackers could inject malicious boot code, as described above in connection with reference number 330, that may enable the attackers to control the UFS device 304 and/or disable security features) and/or to a compromise of the UFS device 304 (e.g., by switching the active Boot LU after injecting malicious code, attackers could take control of the boot process, leading to a complete compromise of the UFS device 304).

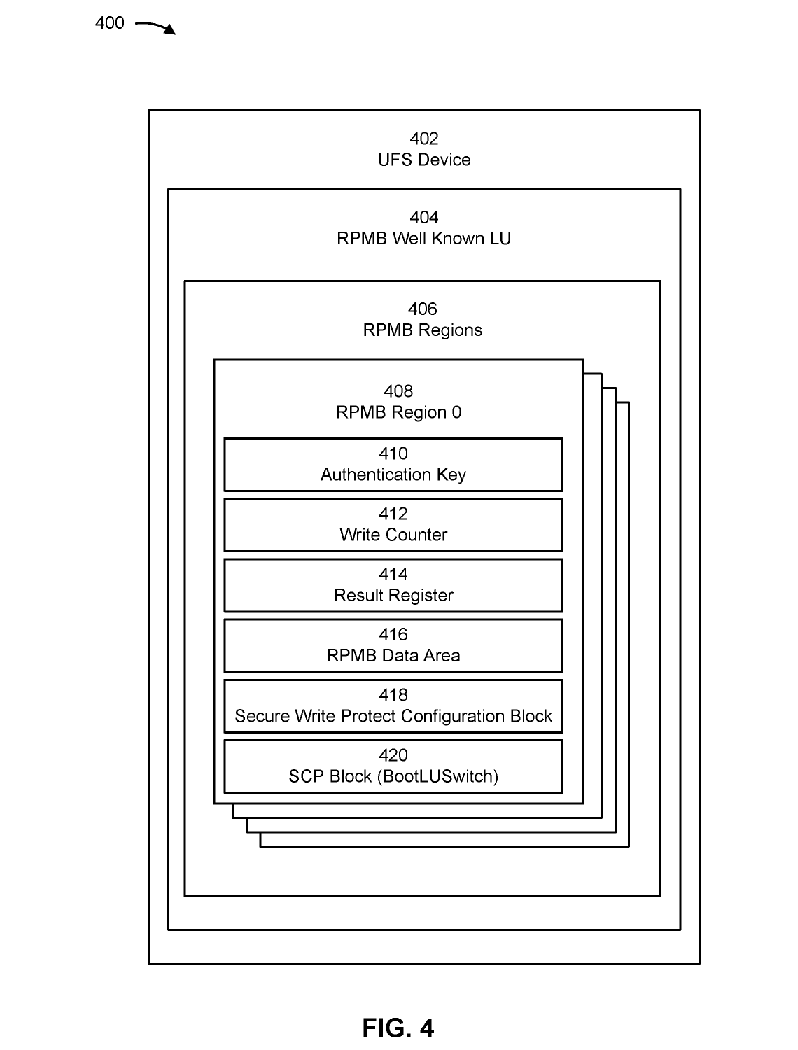

Accordingly, some implementations and techniques described herein enable authentication of requests to update boot LU configurations, thereby protecting the UFS device 304 against malicious attacks, among other examples. For example, some implementations and techniques described herein may use an authentication key and/or a MAC to ensure that only authorized parties can write to a boot LU and/or change a boot LU’s configuration profile. Aspects of authenticating requests to update boot LU configurations are described in more detail below in connection with FIGS. 4-9B.

As indicated above, FIG. 3 is provided as an example. Other examples may differ from what is described with regard to FIG. 3.

FIG. 4 is a diagram of an example 400 of protecting a boot LU configuration using a secure configuration protect (SCP) block of an authentication-key-protected portion of a memory system. The operations described in connection with FIG. 4 may be performed by the memory system 110 and/or one or more components of the memory system 110, such as the memory system controller 115, one or more memory devices 120, and/or one or more local controllers 125; the memory system 204 and/or one or more components of the memory system 204; and/or the UFS device 304 and/or one or more components of the UFS device 304.

As shown in FIG. 4, in some implementations a UFS device 402 (e.g., UFS device 304) may be associated with an RPMB well known LU 404 (sometimes referred to simply as RPMB, for ease of description). In some implementations, the RPMB well known LU 404 is a specialized area within the UFS device 402 specifically designated for storing data that requires high security against replay attacks and/or unauthorized access. The RPMB well known LU 404 may be used to perform secure operations, such as cryptographic mechanisms, to ensure data integrity and authenticity. In some implementations, the RPMB well known LU 404 may be used by the UFS device 402 to store sensitive information, such as authentication keys, security configurations, device-specific data, and/or other data requiring strict access controls, among other examples. In some implementations, the RPMB well known LU 404 may use MACs to provide protection against replay attacks, ensuring that each write operation is unique and authenticated. Moreover, access to data stored in the RPMB well known LU 404 may require authentication to prevent unauthorized entities from reading or writing to this secure area. In some implementations, the RPMB well known LU 404 may be a non-volatile storage area such that the RPMB well known LU 404 retains data even when the UFS device 402 is powered off.

As further shown in FIG. 4, the RPMB well known LU 404 may be associated with multiple RPMB regions 406, such as an RPMB region 0408 as well as RPMB region 1, RPMB region 2 (not shown), and so forth. The RPMB regions 406 may be logically distinct partitions within the RPMB well known LU 404 that are designed to manage and organize secure storage areas. In some implementations the RPMB regions 406 may facilitate secure data storage and access control, ensuring data integrity and protection against replay attacks and unauthorized modifications. Additionally, or alternatively, each RPMB region may have a specific role and/or access control, making the RPMB a versatile and secure storage solution.

In some implementations, the RPMB regions 406 may include the RPMB region 0 408, which may be used to store critical write protection configurations, among other information, as described in more detail below. Moreover, the RPMB regions may include additional regions, such as RPMB region 1, RPMB region 2, and so forth. In some implementations, RPMB region 1, RPMB region 2, and so forth may be designated for various other secure data storage purposes, such as maintaining secure counters, storing cryptographic keys, and/or holding sensitive device-specific data. For example, one or more of the RPMB regions 406 may include secure counters (e.g., to prevent rollback attacks), key storage (e.g., storage of encryption keys used for data protection and authentication), and/or personalization data (e.g., storage of device-specific settings and information that require protection against tampering), among other examples.

As further shown by example 400, the RPMB region 0 408 may store various configurations and/or data associated with the UFS device 402, such as an authentication key 410, a write counter 412, a result register 414, an RPMB data area 416, and/or a secure write protect configuration block 418. In some implementations, the authentication key 410 is a component within RPMB region 0408 used to secure data and verify the authenticity of write and read operations, among other examples. The authentication key 410 may be a cryptographic key shared between the UFS host (e.g., host system 202 and/or UFS host 302) and the UFS device 402. In this regard, when a request is made to write to or read from the RPMB well known LU 404, the UFS host may use the authentication key 410 to produce a MAC that accompanies the request, and/or the UFS device 402 may use the same authentication key 410 to verify the MAC, ensuring that the request is legitimate and has not been tampered with.

The write counter 412 may be a mechanism within the RPMB region 0 408 that provides protection against replay attacks. For example, every time a write operation is performed, the counter may be incremented, and the UFS host may include a current value of the write counter in the MAC calculation for the write operation. In such implementations, the UFS device 402 may check that the write counter value in the request matches the UFS device 402’s own internal counter. If the values do not match, the write operation may be rejected, ensuring that an old, potentially malicious write command cannot be replayed.

The result register 414 may store an outcome of a last operation performed on the RPMB well known LU 404. For example, after a read, write, or authentication operation, the UFS device 402 may update the result register 414 with a status code indicating whether the operation was successful or if an error occurred. In such implementations, the host may be capable of verifying that a host request has been correctly processed and/or may diagnose any issues if the operation fails.

The RPMB data area 416 may be a portion of the RPMB region 0 408 where secure data is stored. In some implementations, the secure data may include a variety of sensitive information such as cryptographic keys, security configurations, secure boot data, or the like. Moreover, the RPMB data area 416 may be protected by the same authentication and/or anti-replay mechanisms that secure the rest of the RPMB well known LU 404, ensuring that unauthorized entities cannot access or modify its contents.

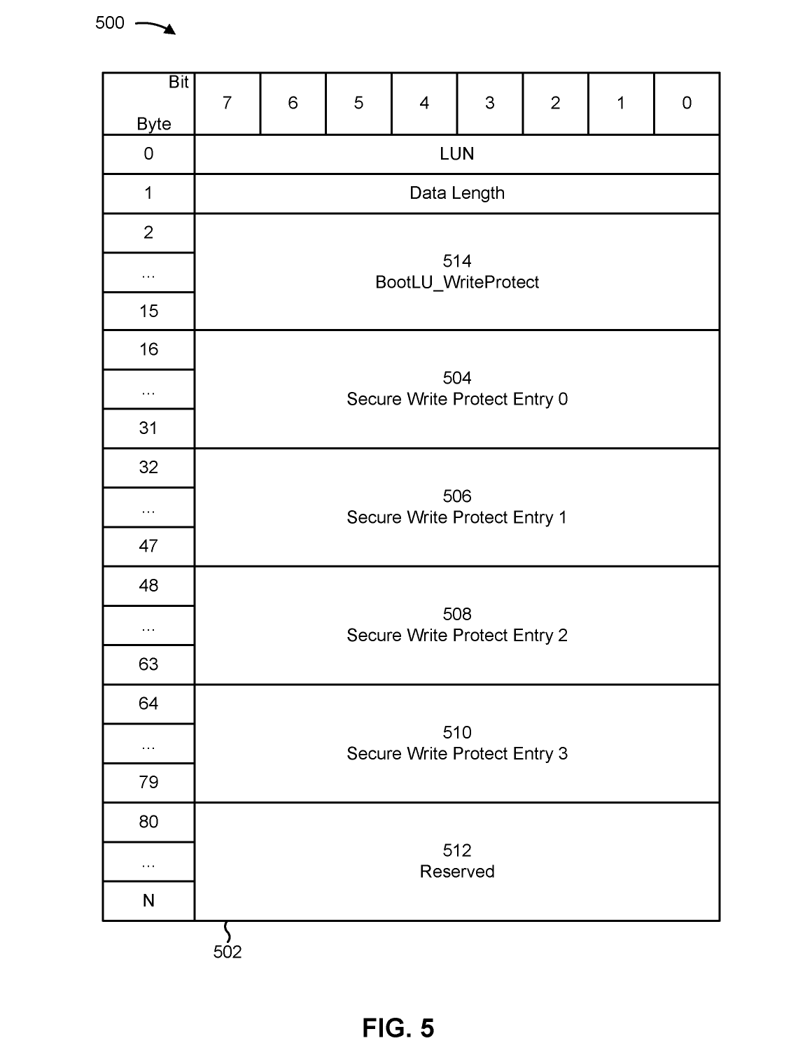

The secure write protect configuration block 418 may be a section within the RPMB region 0 408 that manages write protection statuses of various memory regions within the UFS device 402. In some implementations, the secure write protect configuration block 418 may include parameters that control whether certain areas of memory can be written to and the conditions under which write protection can be changed. Additionally, or alternatively, the secure write protect configuration block 418 may include multiple entries specifying different levels of protection, such as no write protection, power-on write protection (which resets after a power cycle), or permanent write protection (which cannot be changed once set), among other examples. In some implementations, access to the secure write protect configuration block 418 and/or any modifications to the secure write protect configuration block 418 may require authenticated requests, ensuring that only authorized users or entities can alter write protection settings. Aspects of the secure write protect configuration block 418 are described in more detail below in connection with FIG. 5.

In some implementations, in addition to the authentication key 410, the write counter 412, the result register 414, the RPMB data area 416, and/or the secure write protect configuration block 418 described above, the RPMB region 0408 may include an SCP block 420. In some implementations, the SCP block 420 may be used to store one or more boot LU configurations, such as one or more parameters that control whether a boot LU switch can occur, as described in more detail below. In some implementations, accessing and/or modifying the SCP block 420 requires authenticated requests, to ensure that only authorized users or processes can change the boot LU switch status. For example, the authentication process may use an authentication key and/or a MAC derived from shared secrets and/or cryptographic keys, which are securely managed by the RPMB well known LU 404. In this way, by ensuring that changes to the boot LU switch are authenticated, the SCP block 420 may help maintain the integrity of critical data; may prevent unauthorized modifications and/or mitigate risks associated with data corruption, malware, and other security threats; and/or may result in increased reliability.

In some implementations, the SCP block 420 may be used to store a boot LU switch configuration, shown in FIG. 4 as BootLUSwitch. In some implementations, BootLUSwitch may be a similar parameter as the bBootLunEn parameter described above in connection with reference number 310, but which is protected by an authentication-key-protected portion of the memory system (e.g., the RPMB), to protect against unauthorized modifications by an unauthenticated entity (e.g., unauthenticated entity 320). Additionally, or alternatively, the SCP block 420 may be used to protect other attributes and/or flags related to booting the UFS device 402 and/or configuration of the UFS device 402.

In some implementations, the boot LU switch configuration (e.g., BootLUSwitch) may be capable of indicating that a boot LU active at power-on of the UFS device 402 is one of a boot LU indicated by a boot LU enable configuration (e.g., bBootLunEn) or else a selected boot LU of two candidate boot LUs (e.g., a selected one of the first boot LU 306 or the second boot LU 308). For example, the boot LU switch configuration may be set to codepoint 00h (which, in some implementations, may be a default value) to indicate that a boot LU switch is controlled by the attribute bBootLunEn. In such implementations, if the boot LU switch configuration is set to codepoint 00h, the UFS device 402 may use a boot LU that is indicated by the bBootLunEn parameter (in a similar manner as described above in connection with reference numbers 310-312), and, if the boot LU switch configuration is set to a codepoint other than 00h, the BootLUSwitch may take over control of the boot LU switch. More particularly, the boot LU switch configuration may be set to codepoint 01h to indicate that boot of the UFS device 402 is enabled from boot LU A (e.g., the first boot LU 306) and/or the boot LU switch configuration may be set to codepoint 02h to indicate that boot of the UFS device 402 is enabled from boot LU B (e.g., the second boot LU 308).

In some implementations, the SCP block 420 may be associated with 256 bytes (indexed as byte 0 through byte 255), such as when the RPMB well known LU 404 is associated with an RPMB normal mode (described in more detail below in connection with FIG. 5), and/or the SCP block 420 may be associated with 4096 bytes (indexed as byte 0 through byte 4095), such as when the RPMB well known LU 404 is associated with an RPMB advanced mode (also described in more detail below in connection with FIG. 5). In such implementations, a first byte (e.g., byte 0) of the SCP block 420 may be used to indicate the boot LU switch configuration (e.g., BootLUSwitch), with the remaining bytes of the SCP block 420 (e.g., bytes 1-255 in implementations associated with an RPMB normal mode or bytes 1-4095 in implementations associated with an RPMB advanced mode) being reserved, such as for a purpose of storing additional boot LU configurations.

In this way, because the boot LU switch configuration (e.g., BootLUSwitch) may be stored within the SCP block 420 of the RPMB region 0408, only an authenticated entity may be capable of writing to and/or otherwise updating the boot LU switch configuration. For example, in some implementations, the UFS device 402 may receive a request to access (e.g., write to and/or update) the boot LU switch configuration (e.g., BootLUSwitch). In such implementations, because the boot LU switch configuration is protected by the authentication-key-protected portion of the memory system (e.g., the RPMB), before allowing the request, the UFS device 402 may determine whether the request is authenticated based on an authentication key and/or a MAC associated with the request. Accordingly, the UFS device 402 may allow the request to access the boot LU switch configuration based on determining that the request is authenticated, or else may deny the request to access the boot LU switch configuration based on determining that the request is not authenticated.

As indicated above, FIG. 4 is provided as an example. Other examples may differ from what is described with regard to FIG. 4.

FIG. 5 is a diagram of an example 500 of protecting a boot LU configuration using a secure write protect configuration block of an authentication-key-protected portion of a memory system. The operations described in connection with FIG. 5 may be performed by the memory system 110 and/or one or more components of the memory system 110, such as the memory system controller 115, one or more memory devices 120, and/or one or more local controllers 125; the memory system 204 and/or one or more components of the memory system 204; the UFS device 304 and/or one or more components of the UFS device 304; and/or the UFS device 402 and/or one or more components of the UFS device 402.

As shown in FIG. 5, the example 500 may be associated with a secure write protect configuration block 502 for a boot LU. In some implementations, each boot LU may be associated with a respective secure write protect configuration block 502, with each secure write protect configuration block 502 being used to provide write protection for the corresponding boot LU. In some implementations, the secure write protect configuration block 502 may be a portion of normal RPMB resources as defined by JEDEC (sometimes described herein as being associated with a normal RPMB mode), while, in some other implementations, the secure write protect configuration block 502 may be a portion of advanced RPMB resources as defined by JEDEC (sometimes described herein as being associated with an advanced RPMB mode), among other examples. In that regard, the secure write protect configuration block 502 may be an integral component of RPMB resources, designed to enhance data security.

In some implementations, the secure write protect configuration block 502 may be used to manage and enforce the write protection status of specific memory regions within a UFS device. In such implementations, there may be one secure write protect configuration block 502 for each LU (e.g., each boot LU, with the specific boot LU for which a given secure write protect configuration block 502 applies being indicated by the LUN located at the byte indexed 0 of the secure write protect configuration block 502), and/or the secure write protect configuration block 502 may include parameters that control whether data in these protected regions can be written to and/or under what conditions changes to write protection can occur. For example, as indicated by reference numbers 504, 506, 508, and 510, the secure write protect configuration block 502 may include four secure write protect entries, indexed in FIG. 5 as secure write protect entry 0 through secure write protect entry 3, respectively. In such implementations, each secure write protect entity may correspond to one secure write protect area, and/or, if an entry is not used, then the related fields may contain a value of zero.

The secure write protect entries may indicate a write protection level for a corresponding portion of memory. For example, a secure write protect entry may be set to codepoint 00h to indicate that a corresponding memory location is associated with no write protection (e.g., codepoint 00h may be used to indicate that a memory region is not protected and can be freely written to and modified). Additionally, or alternatively, the secure write protect entry may be set to codepoint 01h to indicate that the corresponding memory location is associated with power-on write protection (e.g., codepoint 01h may be used to indicate that a memory region is protected against write operations until the next power cycle of the device, and thus once the device is turned off and on again, this protection can be reset or changed). Additionally, or alternatively, the secure write protect entry may be set to codepoint 02h to indicate that a corresponding memory location is associated with permanent write protection (e.g., codepoint 02h may be used to indicate that the memory region is locked permanently, meaning that the memory region cannot be written to or modified under any circumstance, even after power cycling the device, and thus codepoint 02h may be used for critical regions where data integrity and prevention of unauthorized tampering are paramount). In some implementations, additional codepoints (e.g., 03h and above) may be reserved for future use and/or additional protection modes.

In some implementations, accessing and/or modifying the secure write protect configuration block 502 requires authenticated requests to ensure that only authorized users or processes can change the write protection status of critical memory regions. For example, in a similar manner as described above in connection with FIG. 4, the authentication process may use an authentication key and/or a MAC derived from shared secrets and/or cryptographic keys, which are securely managed by the RPMB (e.g., the RPMB well known LU 404). In this way, by ensuring that changes to the write protection status are authenticated, the secure write protect configuration block 502 may help maintain the integrity of critical data; may prevent unauthorized modifications and/or mitigate risks associated with data corruption, malware, and other security threats; and/or may result in increased reliability.

In some implementations, certain portions of the secure write protect configuration block 502 may be reserved. For example, the four secure write protect entries described above may be stored at bytes indexed as 16 through 79 (as shown in FIG. 4). In such implementations, as indicated by reference number 512, the bytes indexed as 80 through N may be reserved, with N being equal to 255 in implementations in which the secure write protect configuration block 502 is associated with a normal RPMB mode and/or with N being equal to 4095 in implementations in which the secure write protect configuration block 502 is associated with an advanced RPMB mode. Moreover, in traditional applications, the bytes indexed as 2 through 15 may be reserved. However, in the example 500 shown in FIG. 5, the bytes indexed as 2 through 15 may be used to store a boot LU write protection configuration, shown in FIG. 5 as BootLU_WriteProtect. In some implementations, BootLU_WriteProtect may be a similar parameter as the bLUWriteProtect parameter described above in connection with reference number 318, but which is protected by an authentication-key-protected portion of the memory system (e.g., the secure write protect configuration block 502 of the RPMB well known LU 404, among other examples), to protect against unauthorized modifications by an unauthenticated entity (e.g., unauthenticated entity 320).

In such implementations, the protection granularity of the boot LU write protection configuration (e.g., BootLU_WriteProtect) may be an LU, with an LUN field of the secure write protect configuration block 502 (shown in example 500 as being associated with the byte indexed as 0) indicating the boot LU to which the secure write protection applies. Additionally, or alternatively, the boot LU write protection configuration may be capable of indicating that a corresponding boot LU is not write-protected, that the corresponding boot LU is power-on write-protected, and/or that the corresponding boot LU is permanently write-protected, among other examples. For example, the boot LU write protection configuration may be set to codepoint 00h to indicate that the corresponding boot LU is associated with no write protection (or else is secure write-protected only if one or more secure write protect entries associated with the boot LU are set), the boot LU write protection configuration may be set to codepoint 01h to indicate that the corresponding boot LU is associated with power-on write protection, and/or the boot LU write protection configuration may be set to codepoint 02h to indicate that the corresponding boot LU is associated with permanent write protection.

In this way, only an authenticated entity may be capable of writing to and/or otherwise updating the boot LU write protection configuration (e.g., BootLU_WriteProtect). For example, in some implementations, a memory system associated with the secure write protect configuration block 502 (e.g., UFS device 402) may receive a request to access (e.g., write to and/or update) the boot LU write protection configuration (e.g., BootLU_WriteProtect). In such implementations, because the boot LU write protection configuration is protected by the authentication-key-protected portion of the memory system (e.g., the RPMB), before allowing the request, the memory system may determine whether the request is authenticated based on an authentication key and/or a MAC associated with the request, among other examples. Accordingly, the memory system may allow the request to access the boot LU write protection configuration based on determining that the request is authenticated, or else may deny the request to access the boot LU write protection configuration based on determining that the request is not authenticated.

As indicated above, FIG. 5 is provided as an example. Other examples may differ from what is described with regard to FIG. 5.

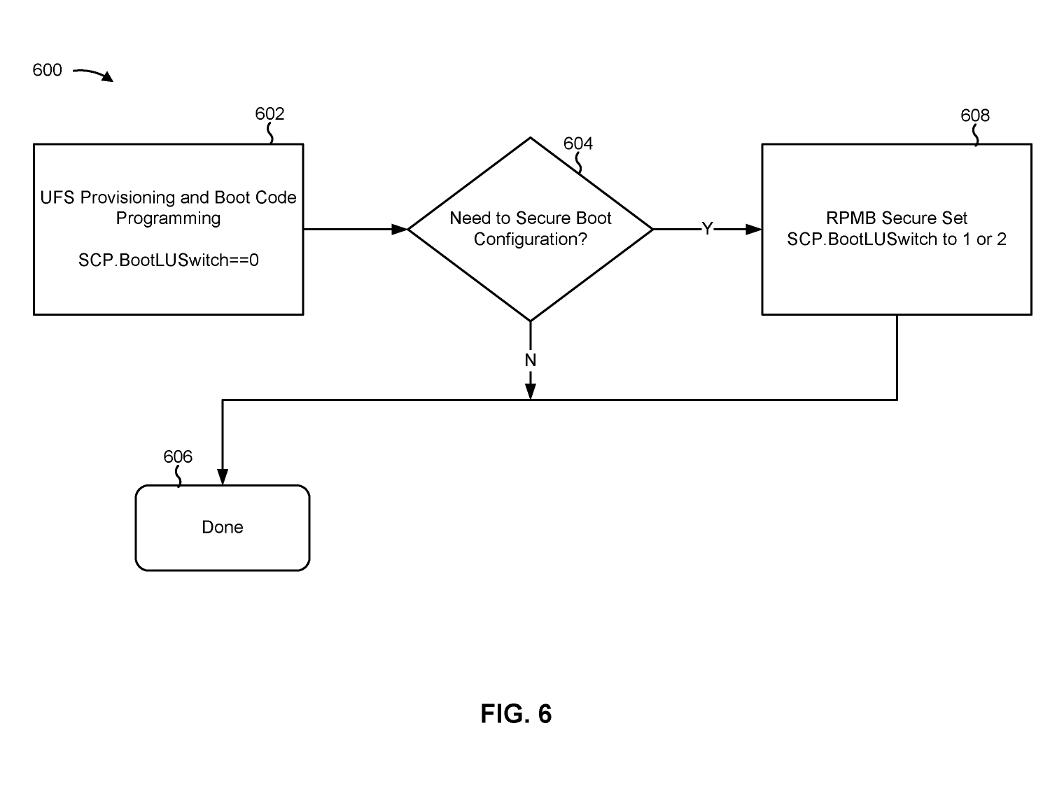

FIG. 6 is a diagram of an example process 600 associated with protecting a boot LU switch configuration using an authentication-key-protected portion of a memory system. The operations described in connection with FIG. 6 may be associated with the memory system 110 and/or one or more components of the memory system 110, such as the memory system controller 115, one or more memory devices 120, and/or one or more local controllers 125; the memory system 204 and/or one or more components of the memory system 204; the UFS device 304 and/or one or more components of the UFS device 304; and/or the UFS device 402 and/or one or more components of the UFS device 402.

As shown in FIG. 6, the example process 600 may be performed during a production line for a product with a UFS storage device (e.g., UFS device 402), based on whether a boot LU switch configuration for the particular memory system is to be secured using an authentication-key-protected portion of the memory system (e.g., the RPMB well known LU 404 and/or the SCP block 420 of the RPMB region 0408, among other examples). As indicated by reference number 602, during initial UFS provisioning and/or boot code programming, a boot LU switch configuration (e.g., BootLUSwitch) may be set to a default codepoint value, such as a codepoint that indicates that a boot LU switch parameter stored elsewhere in the memory system (e.g., bBootLunEn) controls boot LU switch behavior. For example, returning to the example described above in connection with FIG. 4, the boot LU switch configuration may be set by default to codepoint 00h (indicated in FIG. 6 as “SCP.BootLUSwitch==0”), to indicate that a boot LU switch is controlled by the attribute bBootLunEn.

As indicated by reference number 604, the process may include determining whether there is a need to secure a boot configuration associated with the memory system, and, more particularly, a boot LU switch configuration for the memory system. If there is not a need to secure the boot configuration associated with the memory system (indicated using the arrow labeled “N” in connection with the operation indicated by reference number 604), the process 600 may end, as indicated by reference number 606. However, if there is a need to secure the boot configuration associated with the memory system (indicated using the arrow labeled “Y” in connection with the operation indicated by reference number 604), the boot configuration (e.g., the boot LU switch configuration) may be set in the authentication-key protected portion of the memory system (e.g., the SCP block 420 of the RPMB well known LU 404), such as by setting the codepoint associated with boot LU switch configuration to a codepoint other than 00h (as indicated by reference number 608). For example, returning to the example described above in connection with FIG. 4, the boot LU switch configuration may be set to one of codepoint 01h or 02h (indicated in FIG. 6 as “RPMB Secure Set SCP.BootLUSwitch to 1 or 2”), to indicate that a boot LU switch is controlled by the attribute BootLUSwitch and/or to indicate that the boot LU to be used is a first of two candidate boot LUs (e.g., the first boot LU 306 and/or boot LU A) or a second of two candidate boot LUs (e.g., the second boot LU 308 and/or boot LU B). After the corresponding codepoint has been set in the authentication-key protected portion of the memory system (e.g., the SCP block 420 of the RPMB well known LU 404), the process may end, as indicated by reference number 606.

As indicated above, FIG. 6 is provided as an example. Other examples may differ from what is described with regard to FIG. 6.

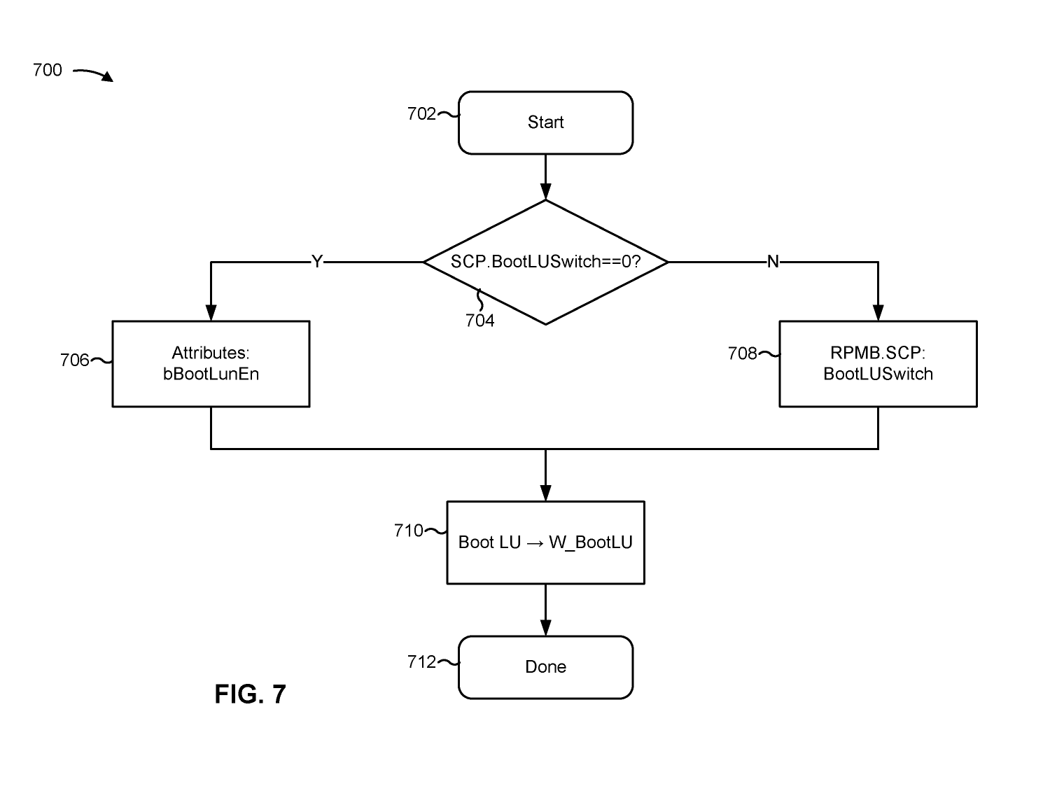

FIG. 7 is a diagram of an example process 700 associated with a memory system determining which of multiple candidate boot LUs is an active boot LU and mapping the active boot LU to a boot well known LU. The operations described in connection with FIG. 7 may be performed by the memory system 110 and/or one or more components of the memory system 110, such as the memory system controller 115, one or more memory devices 120, and/or one or more local controllers 125; the memory system 204 and/or one or more components of the memory system 204; the UFS device 304 and/or one or more components of the UFS device 304; and/or the UFS device 402 and/or one or more components of the UFS device 402. In some implementations, a UFS device may choose which boot LU (e.g., among boot LU A and boot LU B) is an active boot LU and/or may map the active boot LU to a boot well known LU during the boot time based on one or more of the configuration settings described above. For example, the UFS device may first check if BootLUSwitch is set to 0. If not (meaning the active boot LU is defined by BootLUSwitch, as described above), the UFS device may use the value set in BootLUSwitch to map the active boot LU to the boot well known LU. On the other hand, if BootLUSwitch is set to 0 (meaning the active boot LU is defined by bBootLunEn), the UFS device may check bBootLuEn in attributes to determine which boot LU is the active Boot LU, and then may map the active boot LU to the boot well known LU.

More particularly, as indicated by reference number 702, the process 700 may begin, such as by powering on a memory system (e.g., UFS device 402) and/or by a host (e.g., host system 202) requesting access to a boot LU associated with the memory device (in a similar manner as described above in connection with reference number 314). As indicated by reference number 704, the process 700 may include determining whether a boot LU switch configuration (e.g., BootLUSwitch) stored in an authentication-key-protected portion of a memory system (e.g., the RPMB well known LU 404 and/or the SCP block 420) is set to a specific codepoint, such as a default codepoint (e.g., codepoint 00h) as described above in connection with FIGS. 4 and 6. If the boot LU switch configuration is set to the specific codepoint (e.g., 00h), the process may proceed to the operations indicated by reference number 706 (as shown using the arrow labeled “Y” in connection with the operation indicated by reference number 704). More particularly, as indicated by reference number 706, the process 700 may include using a boot LU indicated by a boot LU enable configuration (e.g., bBootLunEn).

However, if the boot LU switch configuration is set to another codepoint (e.g., a codepoint other than 00h), the process may proceed to the operations indicated by reference number 708 (as shown using the arrow labeled “N” in connection with the operations indicated by reference number 704). More particularly, as indicated by reference number 708, the process 700 may include using a boot LU indicated by a boot LU switch configuration (e.g., BootLUSwitch). In this way, the process 700 includes using a boot LU indicated by a boot LU enable configuration (e.g., bBootLunEn) based on the boot LU switch configuration (e.g., BootLUSwitch) being set to a first codepoint (e.g., 00h), using a first boot LU (e.g., boot LU A) of two candidate boot LUs based on the boot LU write protection configuration being set to a second codepoint (e.g., 01h), and/or using a second boot LU (e.g., boot LU B) of the two candidate boot LUs based on the boot LU write protection configuration being set to a third codepoint (e.g., 02h).

Moreover, as indicated by reference number 710, the process may include setting the boot LU indicated by the one of the boot LU enable configuration (e.g., when the process proceeds through the operations indicated by reference number 706) or the boot LU switch configuration (e.g., when the process proceeds through the operations indicated by reference number 708) as the boot well known LU (e.g., W_BootLU), thereby enabling access of the boot LU by the host in a similar manner as described above in connection with reference numbers 312, 314, and 316. After setting the indicated boot LU to the boot well known LU (e.g., W_BootLU), the process 700 may end, as indicated by reference number 712.

As indicated above, FIG. 7 is provided as an example. Other examples may differ from what is described with regard to FIG. 7.

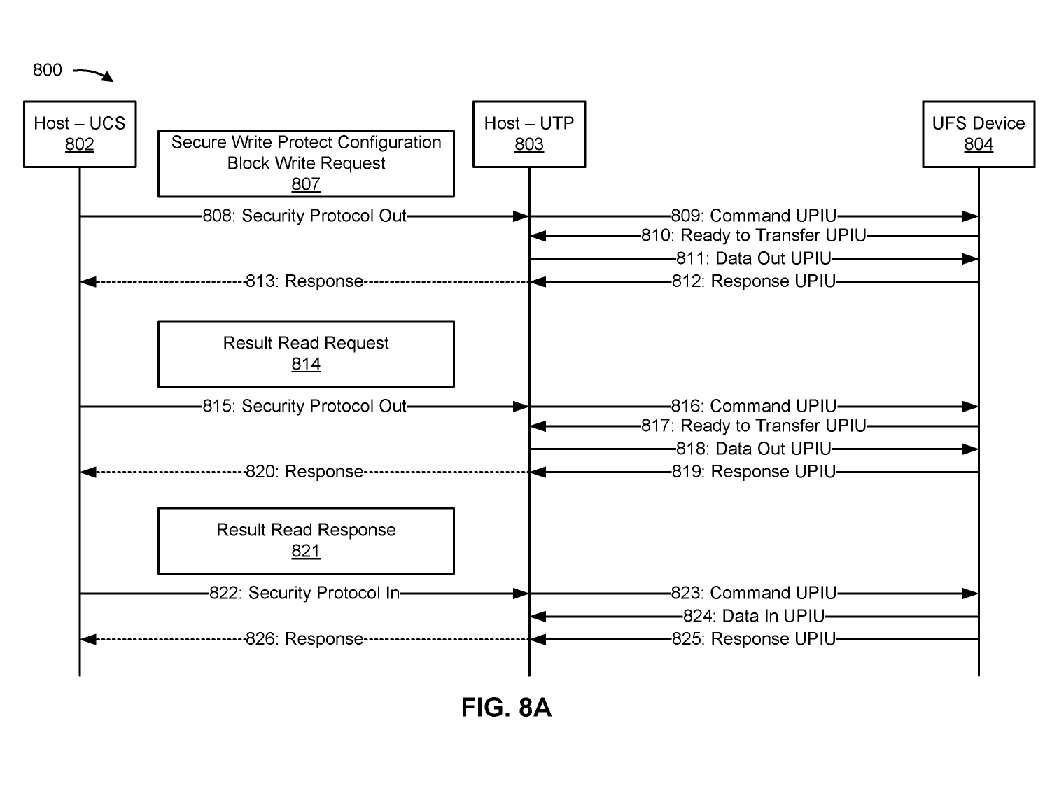

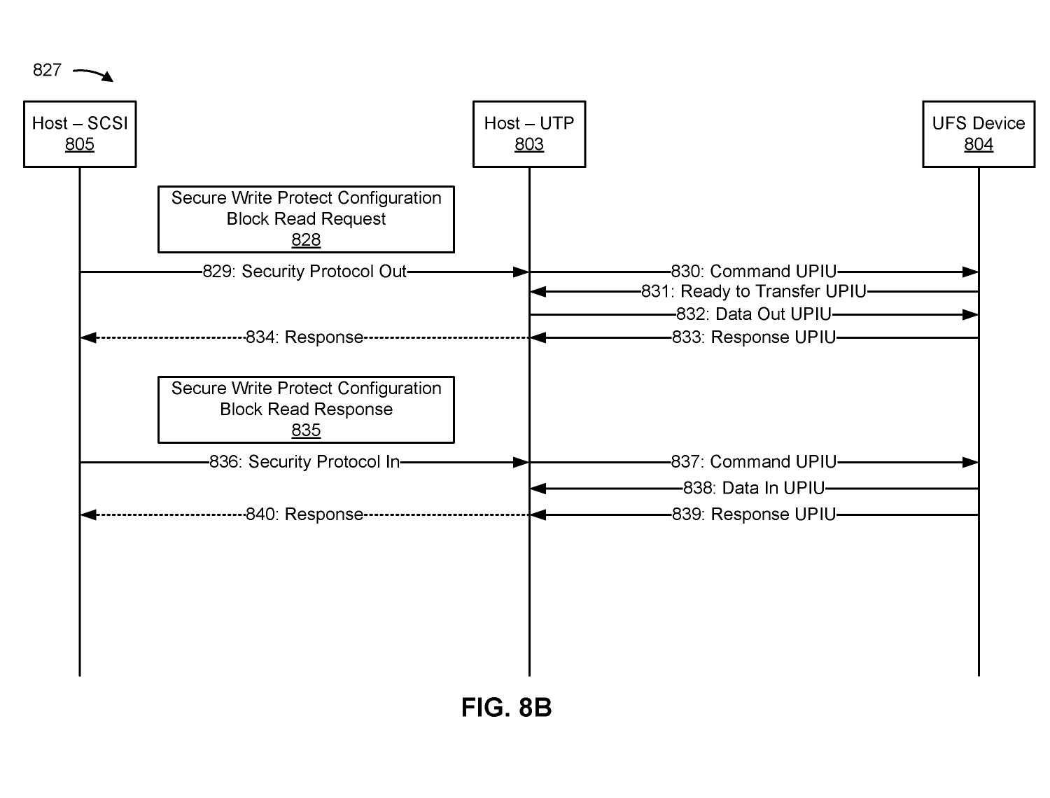

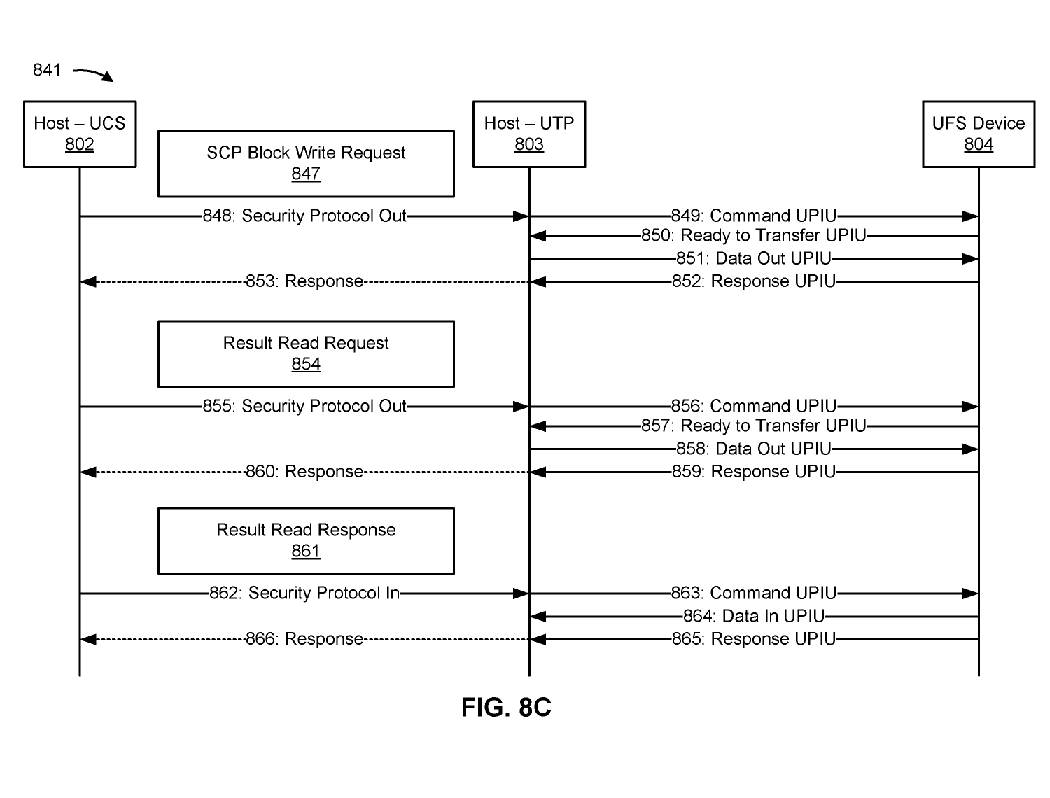

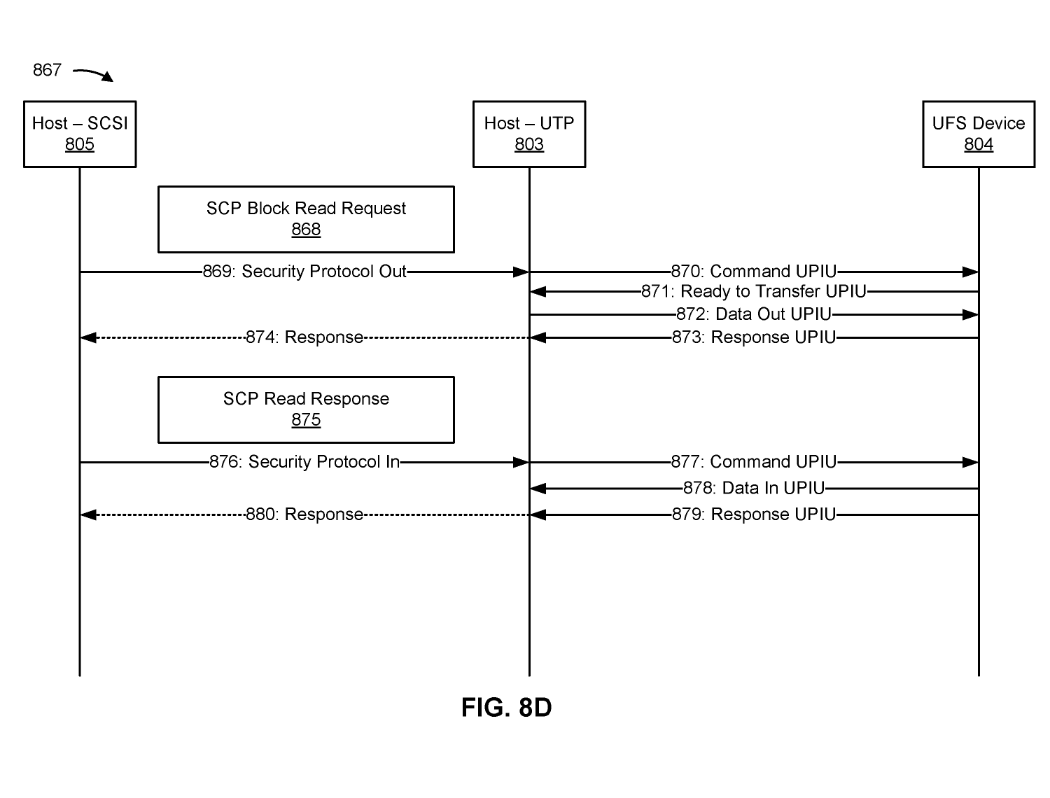

FIGS. 8A-8D are diagrams of examples associated with authenticated read and write operations for boot LU configurations that are protected using an authentication-key-protected portion of a memory system. As shown in FIGS. 8A-8D, the examples involve communications between a UFS host (e.g., host system 105 and/or host system 202) and a UFS device 804 (e.g., memory system 110, memory system 204, UFS device 304, and/or UFS device 402), and, more particularly, between a host UFS command set (host-UCS) component 802, a host UFS transport protocol (host-UTP) component 803, and/or a host small computer system interface (host-SCSI) component 805 and the UFS device 804.

In some implementations, the host-UCS component 802 (shown in FIGS. 8A and 8C) is a component associated with a set of commands that a UFS host uses to interact with the UFS device 804. The command set may be standardized (e.g., defined by JEDEC) and/or may include a variety of commands tailored for the operation and management of non-volatile memory storage (e.g., the UFS device 804). Additionally, or alternatively, the command set may cover operations such as reading, writing, erasing, managing logical units, and/or handling security configurations, among other examples. In some implementations, the host-UCS component 802 may enable the UFS host to effectively communicate with the UFS device 804.

In some implementations, the host-UTP component 803 (shown in FIGS. 8A-8D) is a component associated with the UTP, which may be a protocol that defines how commands, data, and/or responses are transported between the UFS host and the UFS device 804. For example, the host-UTP component 803 may manage the encapsulation and decapsulation of UFS commands and/or data into packets that can be transmitted over the physical interface, such as the MIPI M-PHY, among other examples.

In some implementations, the host-SCSI component 805 (shown in FIGS. 8B and 8D) may be a component of the UFS host associated with an SCSI command set within the UFS protocol framework. For example, the host-SCSI component 805 may leverage a subset of an SCSI command set for UFS host operations. In some implementations, the host-SCSI component 805 may utilize commands for tasks such as reading and writing data, inquiry commands to obtain device information, and/or other essential storage commands.

FIG. 8A shows an example 800 associated with a UFS host performing an authenticated secure write protect configuration block write operation, such as for a purpose of writing the boot LU write protect configuration (e.g., BootLU_WriteProtect) to a secure write protect configuration block (e.g., secure write protect configuration block 502). More particularly, as indicated by reference number 807, in some implementations the example 800 may be associated with a secure write protect configuration block write request. In such implementations, as indicated by reference number 808, the host-UCS component 802 may transmit, to the host-UTP component 803, a security protocol out command associated with the secure write protect configuration block write request. The security protocol out command may be a command utilized by the UFS host to send security-related operations to the UFS device 804. The security protocol out command may be part of an SCSI command set and/or the security protocol out command may allow the host to initiate security tasks, such as configuring encryption, sending security keys, and/or managing security settings. In this way, the purpose of the security protocol out command is to handle actions that involve modifying or setting security measures on the UFS device 804.

As indicated by reference number 809, based on receiving the security protocol out command, the host-UTP component 803 may transmit, to the UFS device 804, a command unit protocol information unit (UPIU) associated with the secure write protect configuration block write request. The command UPIU is the structure used to encapsulate commands that the UFS host sends to the UFS device 804. The command UPIU may include command-related information based on the SCSI command set and may be responsible for initiating various operations on the UFS device 804, such as read/write requests, inquiry commands, and other control commands.

As indicated by reference number 810, based on receiving the command UPIU, the UFS device 804 may transmit, to the host-UTP component 803, a ready to transfer UPIU associated with the secure write protect configuration block write request. The ready to transfer UPIU is used by the UFS device 804 to signal, to the UFS host, that the UFS device 804 is ready to transfer data. In this regard, the ready to transfer UPIU is part of the handshake process that ensures that both the UFS device 804 and the UFS host are synchronized and/or prepared for the data transfer operation, ensuring that buffers are properly allocated and the system is ready to handle the data exchange.

As indicated by reference number 811, the host-UTP component 803 may transmit, to the UFS device 804, a data out UPIU associated with the secure write protect configuration block write request. The data out UPIU carries data from the UFS host to the UFS device 804. For example, when the UFS host needs to write or send data to the UFS device 804, the UFS host (e.g., the host-UTP component 803 of the UFS host) encapsulates the data within the data out UPIU. In some implementations, the data out UPIU contains the actual data payload along with any necessary control information, facilitating the transmission of data blocks to the UFS device 804 for storage.

In the example 800, the data out UPIU indicated by reference number 811 may indicate information associated with the secure write protect configuration block write request. For example, the data out UPIU may include various fields associated with the secure write protect configuration block write request, such as a stuff bytes field, a MAC and/or authentication key field, a data field, a nonce field, a write counter field, an address field, a block count field, a result field, and/or a request/response field.

In implementations associated with the secure write protect configuration block write request, the stuff bytes field, the address field, and/or the result field may be set to a default value (e.g., 000h, among other examples). Additionally, or alternatively, the MAC and/or authentication key field may include a MAC from the UFS host, which may be used by the UFS device 804 to verify that the UFS host is an authenticated entity to write to the secure write protect configuration block. The data field may include one or more of the values described above in connection with FIG. 5, such as an LUN associated with a block LU that is to be write-protected, a data length associated with the block LU that is to be write-protected, and secure write protect entries associated with the block LU that is to be write-protected. Additionally, or alternatively, the data field may be used to indicate the boot LU write protect configuration (e.g., BootLU_WriteProtect) described above in connection with reference number 514. For example, the data field may be used to set the BootLU_WriteProtect to one of codepoint 00h (e.g., no write protection), codepoint 01h (e.g., power-on write protection), or 02h (e.g., permanent write protection), as described above in connection with reference number 514. Additionally, or alternatively, the nonce field may indicate a nonce value (e.g., a random or pseudo-random number that is used only once in cryptographic communication and/or that is used to ensure that old communications cannot be reused in replay attacks, adding uniqueness to each transaction) generated by the UFS host. The write counter field may indicate a current value counter associated with the RPMB. The block count field may include a codepoint to indicate that one block is to be written to the UFS device 804 as part of the secure write operation, such as codepoint 0001h, among other examples.

Additionally, or alternatively, the request/response field may be set to a codepoint to identify that the data out UPIU is associated with the secure write protect configuration block write request. More particularly, in some implementations the UFS device 804 may be associated with various request message types (e.g., a UFS specification associated with the UFS device 804, such as a specification promulgated by JEDEC, may define various request message types), and the request/response field may include a codepoint identifying the corresponding request message type associated with the UFS host request. For example, codepoint 0001h may be used to indicate that the request message type is an authentication key programming request, codepoint 0002h may be used to indicate that the request message type is a write counter read request, codepoint 0003h may be used to indicate that the request message type is an authenticated data write request, codepoint 0004h may be used to indicate that the request message type is an authenticated data read request, codepoint 0005h may be used to indicate that the request message type is a result read request (e.g., when the UFS device 804 is associated with an RPMB normal mode), codepoint 0006h may be used to indicate that the request message type is a secure write protect configuration block write request, codepoint 0007h may be used to indicate that the request message type is a secure write protect configuration block read request, codepoint 0008h may be used to indicate that the request message type is an RPMB purge enable request, and/or codepoint 0009h may be used to indicate that the request message type is an RPMB purge status read request, among other examples. In such implementations, the request/response field may be set to codepoint 0006h to indicate that, in this instance, the request is the secure write protect configuration block write request.

As indicated by reference number 812, based on receiving the data out UPIU, the UFS device 804 may transmit, to the host-UTP component 803, a response UPIU. The response UPIU is used by the UFS device 804 to send responses back to the UFS host (e.g., the host-UTP component 803 of the UFS host). For example, after processing a command, the UFS device 804 may use the response UPIU to return status information, including the success or failure of the command execution, error codes, and other relevant details. In this way, the response UPIU may confirm the completion of the requested operation, allowing the UFS host to proceed accordingly based on the response received. Moreover, as indicated by reference number 813, based on receiving the response UPIU, the host-UTP component 803 may optionally transmit, to the host-UCS component 802, a response associated with the response UPIU.

In some implementations, the UFS host may send a command to the UFS device 804 to retrieve an outcome and/or status of a previously performed operation, such as the secure write protect configuration block write request described above in connection with reference numbers 807-813. More particularly, as indicated by reference number 814, in some implementations the example 800 may be associated with a result read request. In such implementations, as indicated by reference number 815, the host-UCS component 802 may transmit, to the host-UTP component 803, a security protocol out command associated with the result read request, which may be substantially similar to the security protocol out command described above in connection with reference number 807.

As indicated by reference number 816, based on receiving the security protocol out command, the host-UTP component 803 may transmit, to the UFS device 804, a command UPIU associated with the result read request, which may be substantially similar to the message described above in connection with reference number 809. As indicated by reference number 817, based on receiving the command UPIU, the UFS device 804 may transmit, to the host-UTP component 803, a ready to transfer UPIU associated with the result read request, which may be substantially similar to the message described above in connection with reference number 810.

As indicated by reference number 818, the host-UTP component 803 may transmit, to the UFS device 804, a data out UPIU associated with the result read request. In this implementation, the data out UPIU may include data associated with the result read request. The result read request may be a command sent by the UFS host to the UFS device 804 to retrieve the outcome or status of a previously performed operation (which may be stored in the result register 414 of the RPMB region 0), such as the authenticated secure write protect configuration block write operation described above. In this regard, the result read request may be used to verify whether the previous operation succeeded or failed and to obtain any associated error codes or status messages.

In a similar manner as described above in connection with the data out UPIU indicated by reference number 808, the data UPIU associated with the result read request may include the stuff bytes field, the MAC and/or authentication key field, the data field, the nonce field, the write counter field, the address field, the block count field, the result field, and/or the request/response field. In this implementation, most of the fields (e.g., the stuff bytes field, the MAC and/or authentication key field, the data field, the nonce field, the write counter field, the address field, the block count field, and/or the result field) may be set to a default value (e.g., 0000h). Moreover, the request/response field may be set to a codepoint to identify the request as the result read request. More particularly, the request/response field may be set to codepoint 0005h to indicate that the request is the result read request.

As indicated by reference number 819, based on receiving the data out UPIU, the UFS device 804 may transmit, to the host-UTP component 803, a response UPIU associated with the result read request, which may be substantially similar to the message described above in connection with reference number 812. Moreover, as indicated by reference number 820, based on receiving the response UPIU, the host-UTP component 803 may optionally transmit, to the host-UCS component 802, a response associated with the response UPIU, which may be substantially similar to the message described above in connection with reference number 813.

In some implementations, based on receiving the response UPIU indicated by reference number 819 and/or the response indicated by reference number 820, the UFS host may initiate a result read response from the UFS device 804 to the UFS host, as indicated by reference number 821. In such implementations, as indicated by reference number 822, the host-UCS component 802 may transmit, to the host-UTP component 803, a security protocol in command associated with the result read response. The security protocol in command may be used by the UFS host to retrieve security-related information from the UFS device 804. In that regard, the security protocol in command may enable the UFS host to receive security keys, certificates, and/or other security-related data. In some implementations, the security protocol in command may complement the security protocol out command (e.g., the command described above in connection with reference number 807 and/or reference number 814) by providing a mechanism to read and verify security configurations and data from the UFS device 804.

In such implementations, as indicated by reference number 823, based on receiving the security protocol in command, the host-UTP component 803 may transmit, to the UFS device 804, a command UPIU associated with the result read response, which may be substantially similar to the messages described above in connection with reference numbers 809 and 816. As indicated by reference number 824, based on receiving the command UPIU, the UFS device 804 may transmit, to the host-UTP component 803, data in UPIU associated with the result read response. The data in UPIU is the structure used to carry data from the UFS device 804 back to the UFS host. For example, when the UFS host requests data from the UFS device 804 (e.g., through a read command), the UFS device 804 may encapsulate the requested data within the data in UPIU and/or may transmit the data back to the host. In this way, the data in UPIU may contain the data payload and any associated control information, enabling efficient data retrieval from the UFS device 804.

In the implementation shown in FIG. 8A, the data in UPIU may be used to transmit data from the UFS device 804 to the UFS host that is associated with the result read response. In a similar manner as described above in connection with the secure write protect configuration block write request and/or the result read request, the data in UPIU may include various fields, such as the stuff bytes field, the MAC and/or authentication key field, the data field, the nonce field, the write counter field, the address field, the block count field, the result field, and/or the request/response field. In such implementations, the stuff bytes field, the data field, the address field, and/or the block count field may be set to a default value (e.g., 0000h). The MAC and/or authentication key field may include a MAC generated by the UFS device 804. Additionally, or alternatively, the nonce field may indicate a copy of the nonce value generated by the UFS host and/or otherwise associated with the secure write protect configuration block write request. The write counter field may indicate a new counter value (e.g., a counter reflecting the write operation associated with the secure write protect configuration block write request). The result field may include a result code associated with the result read request, which may be a code used to indicate a success or failure associated with the secure write protect configuration block write request and/or similar information, and/or which may be retrieved from, or otherwise associated with, the result register 414 of the RPMB region 0408.

Additionally, or alternatively, the request/response field may be set to a codepoint to identify that the response is the result read response. More particularly, in some implementations the UFS device 804 may be associated with various response message types (e.g., a UFS specification associated with the UFS device 804, such as a specification promulgated by JEDEC, may define various response message types), and the request/response field may include a codepoint identifying the corresponding response message type. For example, codepoint 0100h may be used to indicate that the response message type is an authentication key programming response, codepoint 0200h may be used to indicate that the response message type is write counter read response, codepoint 0300h may be used to indicate that the response message type is an authenticated data write response, codepoint 0400h may be used to indicate that the response message type is an authenticated data read response, codepoint 0500h may be reserved, codepoint 0600h may be used to indicate that the response message type is a secure write protect configuration block write response, codepoint 0700h may be used to indicate that the response message type is a secure write protect configuration block read response, codepoint 0800h may be used to indicate that the response message type is an RPMB purge enable response, and/or codepoint 0900h may be used to indicate that the response message type is an RPMB purge status read response, among other examples. In such implementations, the request/response field of the result read response may be set to codepoint 0600h to indicate that the response is associated with a secure write protect configuration block write response.

Additionally, or alternatively, as indicated by reference number 825, after transmitting the data in UPIU, the UFS device 804 may transmit, to the host-UTP component 803, a response UPIU associated with the result read response, which may be substantially similar to the messages described above in connection with reference number 812 and 819. Moreover, as indicated by reference number 826, based on receiving the response UPIU, the host-UTP component 803 may optionally transmit, to the host-UCS component 802, a response associated with the result read response, which may be substantially similar to the messages described above in connection with reference numbers 813 and 820.

FIG. 8B shows an example 827 associated with a UFS host performing an authenticated secure write protect configuration block read operation, such as for a purpose of reading the boot LU write protect configuration (e.g., BootLU_WriteProtect) from a secure write protect configuration block (e.g., secure write protect configuration block 502). As indicated by reference number 828, in some implementations the example 827 may be associated with a secure write protect configuration block read request. In such implementations, as indicated by reference number 829, the host-SCSI component 805 may transmit, to the host-UTP component 803, a security protocol out command associated with the secure write protect configuration block read request, which may be substantially similar to one or more of the security protocol out commands described above. As indicated by reference number 830, based on receiving the security protocol out command, the host-UTP component 803 may transmit, to the UFS device 804, a command UPIU associated with the secure write protect configuration block read request, which may be substantially similar to one or more of the commands UPIUs described above. As indicated by reference number 831, based on receiving the command UPIU, the UFS device 804 may transmit, to the host-UTP component 803, a ready to transfer UPIU associated with the secure write protect configuration block read request, which may be substantially similar to one or more of the ready to transfer UPIUs described above. As indicated by reference number 832, the host-UTP component 803 may transmit, to the UFS device 804, a data out UPIU associated with the secure write protect configuration block read request.

In this implementation, the data out UPIU may include information associated with the secure write protect configuration block read request. The secure write protect configuration read request is an operation initiated by the UFS host to request the current write protection statuses of certain memory regions within the UFS device. The secure write protect configuration block read request is part of the security and authentication framework involving an authentication-key-protected portion of the memory system (e.g., the RPMB well known LU 404). In some implementations, the secure write protect configuration block read request may include similar fields as those described above in connection with the secure write protect configuration block write request, the result read request, and/or the result read response of example 800, such as the stuff bytes field, the MAC and/or authentication key field, the data field, the nonce field, the write counter field, the address field, the block count field, the result field, and/or the request/response field.

In such implementations, the stuff bytes field, the MAC and/or authentication key field, the write counter field, the address field, and/or the result field may be set to a default value (e.g., 0000h). Additionally, or alternatively, the data field may indicate an LUN associated with the boot LU for which the boot LU write protect configuration (e.g., BootLU_WriteProtect) is to be read. The nonce field may indicate a nonce generated by the UFS host. The block count field may indicate codepoint 0001h (indicating that one block of data is to be read). Moreover, the response/request field may indicate codepoint 0007h to indicate that the request is the secure write protect configuration block read request.

As indicated by reference number 833, based on receiving the data out UPIU, the UFS device 804 may transmit, to the host-UTP component 803, a response UPIU associated with the secure write protect configuration block read request, which may be substantially similar to one or more of the response UPIUs described above. Moreover, as indicated by reference number 834, based on receiving the response UPIU, the host-UTP component 803 may optionally transmit, to the host-SCSI component 805, a response associated with the secure write protect configuration block read request, which may be substantially similar to one or more of the responses described above.

Additionally, or alternatively, in some implementations, the example 827 may be associated with a secure write protect configuration block read response, as indicated by reference number 835. Put another way, based on transmitting the secure write protect configuration block read response described above, the UFS host may initiate a secure write protect configuration block read response from the UFS device 804. In such implementations, as indicated by reference number 836, the host-SCSI component 805 may transmit, to the host-UTP component 803, a security protocol in command associated with the secure write protect configuration block read response, which may be substantially similar to one or more of the security protocol in commands described above. As indicated by reference number 837, based on receiving the security protocol in command, the host-UTP component 803 may transmit, to the UFS device 804, a command UPIU associated with the secure write protect configuration block read response, which may be substantially similar to one or more of the command UPIUs described above. As indicated by reference number 838, the host-UTP component 803 may transmit, to the UFS device 804, a data in UPIU associated with the secure write protect configuration block read response.

In this implementation, the data in UPIU may indicate the secure write protect configuration block read response. The secure write protect configuration block read response is a response message that provides the UFS host with the current secure write protect configuration settings for specific LUs or memory regions within the UFS device 804. The secure write protect configuration block read response is part of the security and authentication framework involving an authentication-key-protected portion of the memory system (e.g., the RPMB well known LU 404). In some implementations, the data in UPIU may include similar fields as those described above in connection with the secure write protect configuration block read request, the result read request, and/or the result read response of example 800, and/or the secure write protect configuration block read request of example 827, such as the stuff bytes field, the MAC and/or authentication key field, the data field, the nonce field, the write counter field, the address field, the block count field, the result field, and/or the request/response field.

In such implementations, the stuff bytes field, the write counter field, and/or the address field may be set to a default value (e.g., 0000h). The MAC and/or authentication key field may include a MAC generated by the UFS device 804. The data field may include the data being read from the secure write protect configuration block (e.g., secure write protect configuration block 502), such as an LUN associated with the boot LU indicated by the data field of the secure write protect configuration block, a data length indicated by the secure write protect configuration block, and/or the one or more secure write protect entries indicated by the secure write protect configuration block. In this regard, the data field may include an indication of the boot LU write protect configuration (e.g., BootLU_WriteProtect) because the boot LU write protect configuration may be stored in the secure write protect configuration block (e.g., at bytes 2-15 of the secure write protect configuration block 502), as described above in connection with FIG. 5. Additionally, or alternatively, the nonce field may indicate a copy of the nonce value generated by the UFS host and/or otherwise associated with the secure write protect configuration block read request. The block count field may indicate codepoint 0001h (e.g., indicating that one block (e.g., the secure write protect configuration block) was read from memory). The result field may include a result code associated with the secure write protect configuration block read request, such as a code indicating a success or failure associated with the secure write protect configuration block read request and/or a code associated with information stored at the result register 414 of the RPMB region 0408. Moreover, the request/response field may be set to a codepoint to identify the response as the secure write protect configuration block read response. For example, the request/response field may be set to codepoint 0700h to indicate that the response is the secure write protect configuration block read response.

Additionally, or alternatively, as indicated by reference number 839, after transmitting the data in UPIU, the UFS device 804 may transmit, to the host-UTP component 803, a response UPIU associated with the secure write protect configuration block read response, which may be substantially similar one or more of the responses UPIUs described above. Moreover, as indicated by reference number 840, based on receiving the response UPIU, the host-UTP component 803 may optionally transmit, to the host-UCS component 802, a response associated with the secure write protect configuration block read response, which may be substantially similar to one or more of the responses described above.

FIG. 8C shows an example 841 associated with a UFS host performing an authenticated SCP block write operation, such as for a purpose of writing the boot LU switch configuration (e.g., BootLUSwitch) to an SCP block (e.g., SCP block 420) of the RPMB (e.g., the RPMB well known LU 404). More particularly, as indicated by reference number 847, in some implementations the example 841 may be associated with an SCP block write request. In such implementations, as indicated by reference number 848, the host-UCS component 802 may transmit, to the host-UTP component 803, a security protocol out command associated with the SCP block write request, which may be substantially similar to one or more of the security protocol out commands described above. As indicated by reference number 849, based on receiving the security protocol out command, the host-UTP component 803 may transmit, to the UFS device 804, a command UPIU associated with the SCP block write request, which may be substantially similar to one or more of the command UPIUs described above. As indicated by reference number 850, based on receiving the command UPIU, the UFS device 804 may transmit, to the host-UTP component 803, a ready to transfer UPIU associated with the SCP block write request, which may be substantially similar to one or more of the ready to transfer UPIUs described above.

As indicated by reference number 851, the host-UTP component 803 may transmit, to the UFS device 804, a data out UPIU associated with the SCP block write request. In this implementation, the data out UPIU may indicate information associated with the SCP block write request. For example, the data out UPIU may include similar fields as described above in connection with FIGS. 8A and 8B, such as the stuff bytes field, the MAC and/or authentication key field, the data field, the nonce field, the write counter field, the address field, the block count field, the result field, and/or the request/response field.

In such implementations, the stuff bytes field, the address field, and/or the result field may be set to a default value (e.g., 0000h). Additionally, or alternatively, the MAC and/or authentication key field may include a MAC from the UFS host, which may be used by the UFS device 804 to verify that the UFS host is an authenticated entity to write to the SCP block. The data field may indicate one or more of the parameters described above in connection with the SCP block 420, such as an LUN associated with a block LU associated with a block LU switch configuration to be written to the SCP block and/or the codepoint associated with the boot LU switch configuration (e.g., BootLUSwitch). For example, the data field may be used to set the BootLUSwitch to one of codepoint 00h to indicate that a boot LU switch is controlled by the attribute bBootLunEn, codepoint 01h to indicate that boot of the UFS device 402 is enabled from boot LU A (e.g., the first boot LU 306), or codepoint 02h to indicate that boot of the UFS device 402 is enabled from boot LU B (e.g., the second boot LU 308). Additionally, or alternatively, the nonce field may indicate a nonce value generated by the UFS host. The write counter field may indicate a current value counter associated with the RPMB. The block count field may include a codepoint to indicate that one block is to be written to the UFS device 804 as part of the secure write operation, such as codepoint 0001h.

Additionally, or alternatively, the request/response field may be set to a codepoint to identify that the data out UPIU is associated with the SCP block write request. More particularly, as described above in connection with examples 800 and 827, the UFS device 804 may be associated with various request message types, such as codepoint 0001h through codepoint 0009h as described above, among other examples. In implementations involving the SCP block, additional codepoints may be defined to support request message types associated with the SCP block. For example, codepoint 000Ah may be used to indicate that the request message type is an SCP block write request, and/or codepoint 000Bh may be used to indicate that the request message type is an SCP block read request. In such implementations, the request/response field may be set to codepoint 000Ah to indicate that the request is the SCP block write request.

As indicated by reference number 852, based on receiving the data out UPIU, the UFS device 804 may transmit, to the host-UTP component 803, a response UPIU associated with the SCP block write request, which may be substantially similar to one or more of the response UPIUs described above. Moreover, as indicated by reference number 853, based on receiving the response UPIU, the host-UTP component 803 may optionally transmit, to the host-UCS component 802, a response associated with the SCP block write request, which may be substantially similar to one or more of the responses described above.

In a similar manner as described above in connection with the secure write protect configuration block write request, in some implementations the UFS host may send a command to the UFS device 804 to retrieve an outcome and/or status of a previously performed operation, such as the SCP block write request described above in connection with reference numbers 847-853. More particularly, as indicated by reference number 854, in some implementations the example 841 may be associated with a result read request. In such implementations, as indicated by reference number 855, the host-UCS component 802 may transmit, to the host-UTP component 803, a security protocol out command associated with the result read request, which may be substantially similar to one or more of the security protocol out commands described above.

As indicated by reference number 856, based on receiving the security protocol out command, the host-UTP component 803 may transmit, to the UFS device 804, a command UPIU associated with the result read request, which may be substantially similar to one or more of the command UPIUs described above. As indicated by reference number 857, based on receiving the command UPIU, the UFS device 804 may transmit, to the host-UTP component 803, a ready to transfer UPIU associated with the result read request, which may be substantially similar to one or more of the ready to transfer UPIUs described above.

As indicated by reference number 858, the host-UTP component 803 may transmit, to the UFS device 804, a data out UPIU associated with the result read request. In this implementation, the data out UPIU may include data associated with the result read request, which may be similar to the result read request described above in connection with the data out UPIU of reference number 818. In that regard, the data out UPIU associated with the result read request may include the stuff bytes field, the MAC and/or authentication key field, the data field, the nonce field, the write counter field, the address field, the block count field, the result field, and/or the request/response field. In this implementation, most of the fields (e.g., the stuff bytes field, the MAC and/or authentication key field, the data field, the nonce field, the write counter field, the address field, the block count field, and/or the result field) may be set to a default value (e.g., 0000h). Moreover, the request/response field may be set to codepoint 0005h to indicate that the request is the result read request.

As indicated by reference number 859, based on receiving the data out UPIU, the UFS device 804 may transmit, to the host-UTP component 803, a response UPIU associated with the result read request, which may be substantially similar to one or more of the response UPIUs described above. Moreover, as indicated by reference number 860, based on receiving the response UPIU, the host-UTP component 803 may optionally transmit, to the host-UCS component 802, a response associated with the result read request, which may be substantially similar to one or more of the responses described above.

In some implementations, based on receiving the response UPIU indicated by reference number 859 and/or the response indicated by reference number 860, the UFS host may initiate a result read response from the UFS device 804 to the UFS host, as indicated by reference number 861, which may be substantially similar to the result read response described above in connection with reference number 821. In such implementations, as indicated by reference number 862, the host-UCS component 802 may transmit, to the host-UTP component 803, a security protocol in command associated with the result read response, which may be substantially similar to one or more of the security protocol in commands described above. As indicated by reference number 863, based on receiving the security protocol in command, the host-UTP component 803 may transmit, to the UFS device 804, a command UPIU associated with the result read response, which may be substantially similar to one or more of the command UPIUs described above.

As indicated by reference number 864, based on receiving the command UPIU, the UFS device 804 may transmit, to the host-UTP component 803, a data in UPIU associated with the result read response. In this implementation, the data in UPIU may be used to transmit data from the UFS device 804 to the UFS host that is associated with the result read response. In that regard, and in a similar manner as described above in connection with the data in UPIU associated with reference number 824, the data in UPIU may include various fields, such as the stuff bytes field, the MAC and/or authentication key field, the data field, the nonce field, the write counter field, the address field, the block count field, the result field, and/or the request/response field. In such implementations, the stuff bytes field, the data field, the address field, and/or the block count field may be set to a default value (e.g., 0000h). The MAC and/or authentication key field may include a MAC generated by the UFS device 804. The nonce field may indicate a copy of the nonce value generated by the UFS host and/or otherwise associated with the SCP block write request. The write counter field may indicate a new counter value (e.g., a counter reflecting the write operation associated with the SCP block write request). The result field may include a result code associated with the result read request, which may be a code used to indicate a success or failure associated with the SCP block write request and/or similar information, and/or which may be associated with a result stored in the result register 414 of the RPMB region 0408.

Additionally, or alternatively, the request/response field may be set to a codepoint to identify the response as the result read response. More particularly, as described above in connection with examples 800 and 827, the UFS device 804 may be associated with various response message types, such as codepoint 0100h through codepoint 0900h as described above, among other examples. In implementations involving the SCP block, additional codepoints may be defined to support response message types associated with the SCP block. For example, codepoint 0A00h may be used to indicate that the request message type is an SCP block write response, and/or 0B00h may be used to indicate that the response message type is an SCP block read response. In such implementations, the request/response field may be set to codepoint 0A00h to indicate that the response is the SCP block write response.

Additionally, or alternatively, as indicated by reference number 865, after transmitting the data in UPIU, the UFS device 804 may transmit, to the host-UTP component 803, a response UPIU associated with the result read response, which may be substantially similar to one or more of the response UPIUs described above. Moreover, as indicated by reference number 866, based on receiving the response UPIU, the host-UTP component 803 may optionally transmit, to the host-UCS component 802, a response associated with the result read response, which may be substantially similar to one or more of the responses described above.

FIG. 8D shows an example 867 associated with a UFS host performing an authenticated SCP block read operation, such as for a purpose of reading the boot LU switch configuration (e.g., BootLUSwitch) from an SCP block (e.g., SCP block 420). As indicated by reference number 868, in some implementations the example 867 may be associated with an SCP read request. In such implementations, as indicated by reference number 869, the host-SCSI component 805 may transmit, to the host-UTP component 803, a security protocol out command associated with the SCP read request, which may be substantially similar to one or more of the security protocol out commands described above. As indicated by reference number 870, based on receiving the security protocol out command, the host-UTP component 803 may transmit, to the UFS device 804, a command UPIU associated with the SCP read request, which may be substantially similar to one or more of the command UPIUs described above. As indicated by reference number 871, based on receiving the command UPIU, the UFS device 804 may transmit, to the host-UTP component 803, a ready to transfer UPIU associated with the SCP read request, which may be substantially similar to one or more of the ready to transfer UPIUs described above. As indicated by reference number 872, the host-UTP component 803 may transmit, to the UFS device 804, a data out UPIU associated with the SCP read request.

In this implementation, the data out UPIU may include information associated with the SCP block read request. In some implementations, the SCP block read request may include similar fields as those described above in connection with examples 800, 827, and/or 841, such as the stuff bytes field, the MAC and/or authentication key field, the data field, the nonce field, the write counter field, the address field, the block count field, the result field, and/or the request/response field.

In such implementations, the stuff bytes field, the MAC and/or authentication key field, the write counter field, the address field, and/or the result field may be set to a default value (e.g., 0000h). Additionally, or alternatively, the data field may indicate an LUN associated with the boot LU for which the boot LU switch configuration (e.g., BootLUSwitch) is to be read. The nonce field may indicate a nonce generated by the UFS host. The block count field may indicate codepoint 0001h (indicating that one block of data is to be read). Moreover, the response/request field may indicate codepoint 000Bh to indicate that the request is the SCP block read request.

As indicated by reference number 873, based on receiving the data out UPIU, the UFS device 804 may transmit, to the host-UTP component 803, a response UPIU associated with the SCP read request, which may be substantially similar to one or more of the response UPIUs described above. Moreover, as indicated by reference number 874, based on receiving the response UPIU, the host-UTP component 803 may optionally transmit, to the host-SCSI component 805, a response associated with the SCP read request, which may be substantially similar to one or more of the responses described above.

Additionally, or alternatively, in some implementations, the UFS host may initiate an SCP block read response from the UFS device 804 to the UFS host, as indicated by reference number 875. In such implementations, as indicated by reference number 876, the host-SCSI component 805 may transmit, to the host-UTP component 803, a security protocol in command associated with the SCP block read response, which may be substantially similar to one or more of the security protocol in commands described above. As indicated by reference number 877, based on receiving the security protocol in command, the host-UTP component 803 may transmit, to the UFS device 804, a command UPIU associated with the SCP block read response, which may be substantially similar to one or more of the command UPIUs described above. As indicated by reference number 878, the host-UTP component 803 may transmit, to the UFS device 804, a data in UPIU associated with the SCP block read response.

In this implementation, the data in UPIU may indicate the SCP block read response. In some implementations, the data in UPIU may include similar fields as those described above in connection with examples 800, 827, and/or 841, such as the stuff bytes field, the MAC and/or authentication key field, the data field, the nonce field, the write counter field, the address field, the block count field, the result field, and/or the request/response field.

In such implementations, the stuff bytes field, the write counter field, and/or the address field may be set to a default value (e.g., 0000h). The MAC and/or authentication key field may include a MAC generated by the UFS device 804. The data field may include the data being read from the SCP block (e.g., SCP block 420), such as an LUN associated with the boot LU indicated by the data field of the SCP block read request and/or the boot LU switch configuration (e.g., BootLUSwitch) associated with the boot LU. Additionally, or alternatively, the nonce field may indicate a copy of the nonce value generated by the UFS host and/or otherwise associated with the SCP block read request. The block count field may indicate 0001h (e.g., indicating that one block, the SCP block, was read from memory). The result field may include a result code associated with the SCP block read request, such as a code indicating a success or failure associated with the SCP block read request, which may be associated with the result register 414 of the RPMB region 0408. Moreover, the request/response field may be set to a codepoint to identify the response as the SCP block read response. For example, the request/response field may be set to codepoint 0B00h to indicate that the response is the SCP block read response.

Additionally, or alternatively, as indicated by reference number 879, after transmitting the data in UPIU, the UFS device 804 may transmit, to the host-UTP component 803, a response UPIU associated with the SCP block read response, which may be substantially similar one or more of the response UPIUs described above. Moreover, as indicated by reference number 880, based on receiving the response UPIU, the host-UTP component 803 may optionally transmit, to the host-UCS component 802, a response associated with the SCP block read response, which may be substantially similar to one or more of the responses described above.

As indicated above, FIGS. 8A-8D are provided as examples. Other examples may differ from what is described with regard to FIGS. 8A-8D.

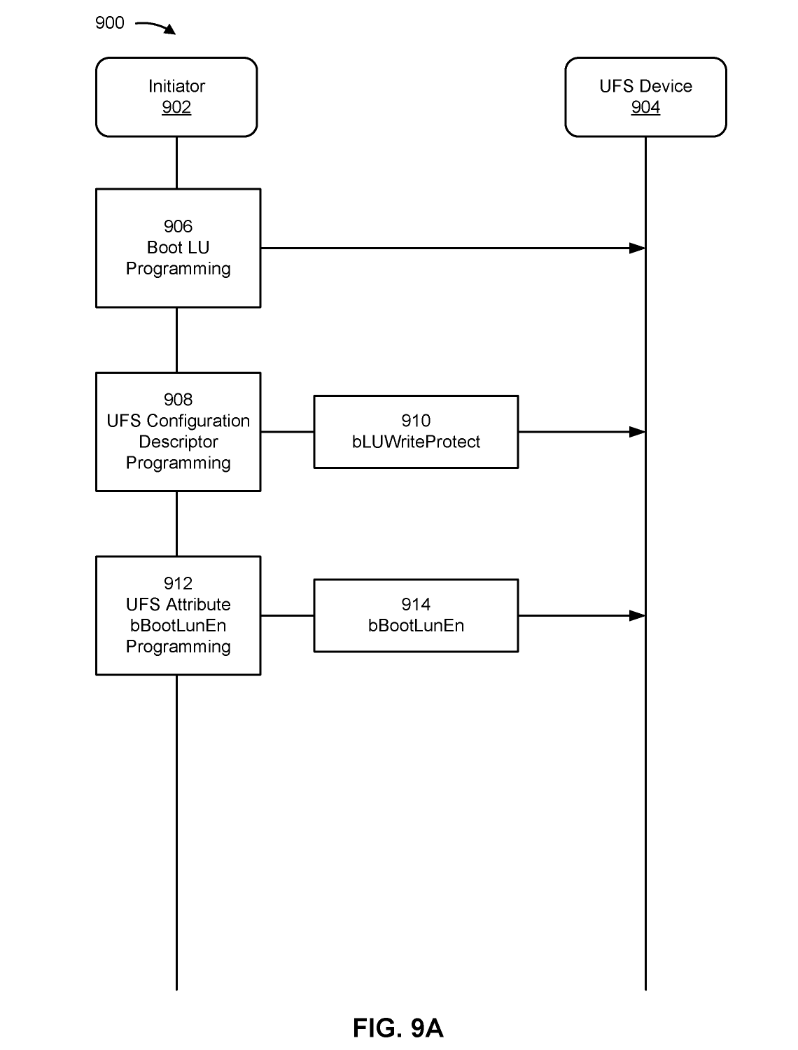

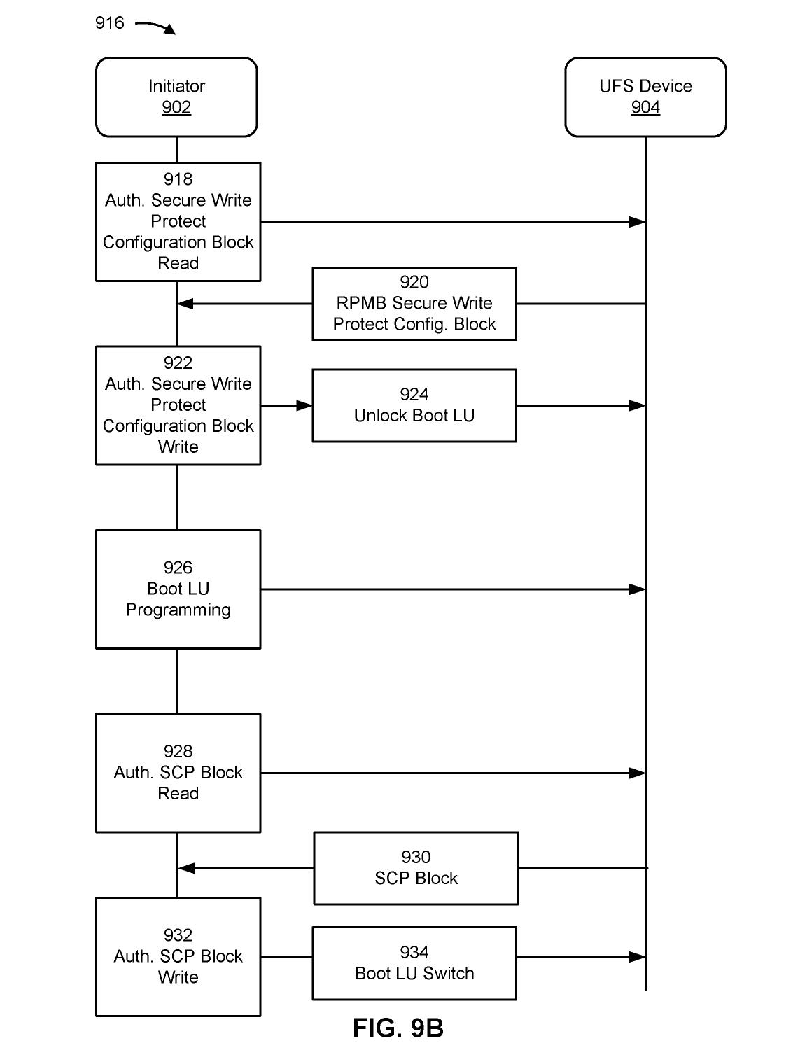

FIGS. 9A-9B are examples associated with protecting boot LU configurations using an authentication-key-protected portion of a memory system. As shown in FIGS. 9A-9B, the examples involve communications between an initiator 902 (e.g., host system 105, host system 202, host-UCS component 802, host-UTP component 803, and/or host-SCSI component 805) and a UFS device 904 (e.g., memory system 110, memory system 204, UFS device 304, UFS device 402, and/or UFS device 804).

FIG. 9A shows an example 900 associated with programming a boot LU and/or one or more configurations associated with the boot LU when boot LU configurations are not protected by an authentication-key-protected portion of a memory system (e.g., RPMB). As indicated by reference number 906, the initiator 902 (which, in this example, may or may not be an authenticated entity) may write boot LU programming to the UFS device 904 without the use of an authentication key and/or a MAC. Similarly, as indicated by reference number 908, the initiator may write UFS configuration descriptor programming to the UFS device 904 without the use of an authentication key and/or a MAC. For example, as indicated by reference number 910, the initiator 902 may be able to write to and/or update the boot LU write protect configuration (e.g., bLUWriteProtect) without the use of an authentication key and/or a MAC. Similarly, as indicated by reference number 912, the initiator may write UFS attribute programming to the UFS device 904 without the use of an authentication key and/or a MAC. For example, as indicated by reference number 914, the initiator 902 may be able to write to and/or update the boot LU enable configuration (e.g., bBootLunEn) without the use of an authentication key and/or a MAC.

On the other hand, FIG. 9B shows an example 916 associated with programming a boot LU and/or one or more configurations associated with the boot LU when boot LU configurations are protected by an authentication-key-protected portion of a memory system (e.g., RPMB). In this implementation, in order to program a boot LU, the initiator 902 must first unlock a write protection associated with the boot LU, such as by setting the BootLU_WriteProtect to codepoint 0000h. More particularly, as indicated by reference number 918, the initiator 902 may transmit, to the UFS device 904, an authenticated secure write protect configuration block read request (e.g., the secure write protect configuration block read request described above in connection with example 827). As indicated by reference number 920, if, using an authentication key and/or a MAC (among other examples), the UFS device 904 determines that the initiator 902 is an authorized entity to access the secure write protect configuration block, the UFS device 904 may transmit, to the initiator 902, information associated with the secure write protect configuration block, such as an indication of the BootLU_WriteProtect parameter.

As indicated by reference number 922, the initiator 902 may transmit, to the UFS device 904, an authenticated secure write protect configuration block write request (e.g., the secure write protect configuration block write request described above in connection with example 800). For example, as indicated by reference number 924, the initiator 902 may unlock the boot LU (e.g., remove write protection from the boot LU), such as by writing a codepoint 0000h to the BootLU_WriteProtect parameter stored in the secure write protect configuration block. As indicated by reference number 926, once the boot LU has been unlocked, the initiator 902 may write the boot LU programming to the UFS device 904.

Similarly, in order to switch between boot LUs, the initiator 902 may need to first perform an authenticated read and write operation associated with the SCP block (e.g., the secure block that stores the boot LU switch configuration). More particularly, as indicated by reference number 928, the initiator 902 may transmit, to the UFS device 904, an authenticated SCP block read request (e.g., the SCP block read request described above in connection with example 867). As indicated by reference number 930, if, using an authentication key and/or a MAC (among other examples), the UFS device 904 determines that the initiator 902 is an authorized entity to access the SCP block, the UFS device 904 may transmit, to the initiator 902, information associated with the SCP block, such as an indication of the BootLUSwitch parameter.

As indicated by reference number 932, the initiator 902 may transmit, to the UFS device 904, an authenticated SCP block write request (e.g., the SCP write request described above in connection with example 841). For example, as indicated by reference number 934, the initiator 902 may switch the boot LU (e.g., switch from one of boot LU A or boot LU B to the other one of boot LU A or boot LU B), such as by writing one of codepoint 01h or 02h to the BootLUSwitch parameter stored in the SCP block. In this way, modifications to boot LUs and/or switching between boot LUs may be limited to authenticated entities, thereby improving the security and/or reliability of the UFS device 904.

As indicated above, FIGS. 9A-9B are provided as examples. Other examples may differ from what is described with regard to FIGS. 9A-9B.

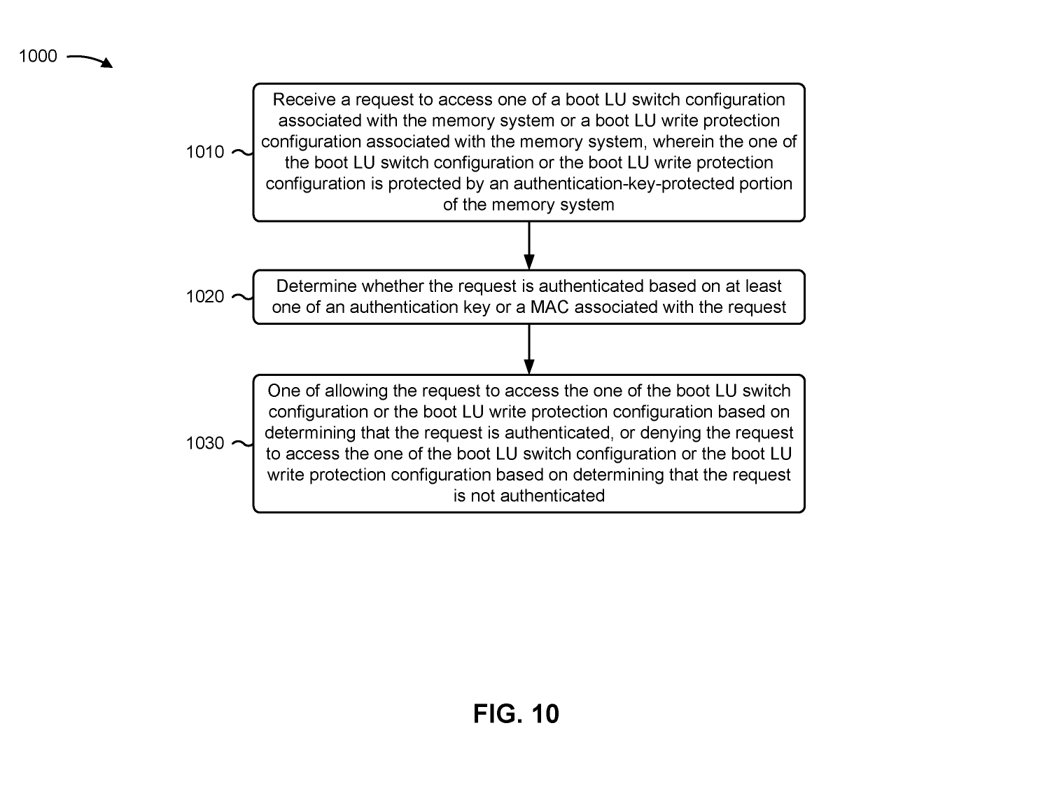

FIG. 10 is a flowchart of an example method 1000 associated with protecting boot LU configurations using an authentication-key-protected portion of a memory system. In some implementations, a memory system (e.g., the memory system 110, memory system 204, UFS device 304, UFS device 402, UFS device 804, and/or UFS device 904) may perform or may be configured to perform the method 1000. In some implementations, another device or a group of devices separate from or including the memory system (e.g., host system 105, host system 202, UFS host 302, and/or initiator 902) may perform or may be configured to perform the method 1000. Additionally, or alternatively, one or more components of the memory system (e.g., memory system controller 115 and/or local controller 125) may perform or may be configured to perform the method 1000. Thus, means for performing the method 1000 may include the memory system and/or one or more components of the memory system. Additionally, or alternatively, a non-transitory computer-readable medium may store one or more instructions that, when executed by the memory system, cause the memory system to perform the method 1000.

As shown in FIG. 10, the method 1000 may include receiving a request to access one of a boot LU switch configuration associated with the memory system or a boot LU write protection configuration associated with the memory system, wherein the one of the boot LU switch configuration or the boot LU write protection configuration is protected by an authentication-key-protected portion of the memory system (block 1010). For example, as described above in connection with FIGS. 4 and 5, a UFS device 402 may receive a request to access the BootLUSwitch parameter stored in the SCP block 420 of the RPMB well known LU 404 and/or the BootLU_WriteProtect parameter stored in the secure write protect configuration block 418, 502 of the RPMB well known LU 404, among other examples.

As further shown in FIG. 10, the method 1000 may include determining whether the request is authenticated based on at least one of an authentication key or a MAC associated with the request (block 1020). For example, as described above in connection with FIGS. 8A-9B, when the boot LU configurations are stored in the RPMB well known LU 404, the UFS device 804, 904 may authenticate any requests to access the boot LU configurations (e.g., BootLUSwitch and/or BootLU_WriteProtect) based at least in part on an authentication key associated with the request and/or a MAC associated with the request, among other examples.

As further shown in FIG. 10, the method 1000 may include one of: allowing, by the memory system, the request to access the one of the boot LU switch configuration or the boot LU write protection configuration based on determining that the request is authenticated, or denying, by the memory system, the request to access the one of the boot LU switch configuration or the boot LU write protection configuration based on determining that the request is not authenticated (block 1030). For example, as described above in connection with FIGS. 4-5, the UFS device 402 may allow requests to access the boot LU configurations (e.g., BootLUSwitch and/or BootLU_WriteProtect) when the UFS host has been authenticated based on an authentication key and/or MAC associated with the request, and the UFS device 402 may deny requests to access the boot LU configurations when the UFS host has not been authenticated based on an authentication key and/or MAC associated with the request, among other examples.

The method 1000 may include additional aspects, such as any single aspect or any combination of aspects described below and/or described in connection with one or more other methods or operations described elsewhere herein.

In a first aspect, the authentication-key-protected portion of the memory system is associated with a RPMB of the memory system. For example, as described above in connection with FIGS. 4 and 5, the authentication-key-protected portion may be associated with the RPMB and/or may be the RPMB well known LU 404, among other examples.

In a second aspect, alone or in combination with the first aspect, the one of the boot LU switch configuration or the boot LU write protection configuration is the boot LU write protection configuration, and the boot LU write protection configuration is associated with a secure write protect configuration block associated with region 0 of the RPMB. For example, as described above in connection with FIGS. 4 and 5, the boot LU write protection configuration (e.g., BootLU_WriteProtect) may be stored in the secure write protect configuration block 418 of the RPMB well known LU 404, among other examples.

In a third aspect, alone or in combination with one or more of the first and second aspects, the secure write protect configuration block indicates that one of a boot LU is not write-protected, the boot LU is power-on write-protected, or the boot LU is permanently write-protected. For example, as described above in connection with FIG. 5, the secure write protect configuration block 502, and more particularly the BootLU_WriteProtect stored therein, may indicate that a boot LU is not write-protected (e.g., using codepoint 00h), the boot LU is power-on write-protected (e.g., using codepoint 01h), or the boot LU is permanently write-protected (e.g., using codepoint 02h), among other examples.

In a fourth aspect, alone or in combination with one or more of the first through third aspects, the one of the boot LU switch configuration or the boot LU write protection configuration is the boot LU switch configuration, and the boot LU switch configuration is associated with an SCP block associated with region 0 of the RPMB. For example, as described above in connection with FIG. 4, the boot LU switch configuration (e.g., BootLUSwitch) may be stored in the SCP block 420 of the RPMB well known LU 404, among other examples.

In a fifth aspect, alone or in combination with one or more of the first through fourth aspects, the SCP block indicates that a boot LU active at power-on of the memory system is one of a boot LU indicated by a boot LU enable configuration, or a selected boot LU of two candidate boot LUs. For example, as described above in connection with FIG. 4, the SCP block 420, and more particularly the BootLUSwitch stored therein, may indicate that a boot LU active at power-on of the UFS device 402 is a boot LU indicated by a boot LU enable configuration (e.g., bBootLunEn) (e.g., using codepoint 00h), a first boot LU (e.g., boot LU A) of two candidate boot LUs (e.g., using codepoint 01h), or a second boot LU (e.g., boot LU B) of the two candidate boot LUs (e.g., using codepoint 02h), among other examples.

In a sixth aspect, alone or in combination with one or more of the first through fifth aspects, the method 1000 includes receiving, by the memory system from a host system, at least one of a command associated with an SCP block write request corresponding to the boot LU switch configuration, a command associated with an SCP block read request corresponding to the boot LU switch configuration, a command associated with an SCP block write response corresponding to the boot LU switch configuration, or a command associated with an SCP block read response corresponding to the boot LU switch configuration. For example, as described above in connection with FIGS. 8C and 8D, to read the BootLUSwitch parameter from the SCP block and/or to write the BootLUSwitch parameter to the SCP block, the UFS device 804 may receive commands (e.g., command UPIUs) associated with an SCP block write request (e.g., using codepoint 000Ah), an SCP block read request (e.g., using codepoint 000Bh), an SCP block write response (e.g., using codepoint 0A00h), and/or an SCP block read response (e.g., using codepoint 0B00h), among other examples.

In a seventh aspect, alone or in combination with one or more of the first through sixth aspects, the one of the boot LU switch configuration or the boot LU write protection configuration is the boot LU switch configuration, and the method 1000 further comprises performing, by the memory system, one of using a boot LU indicated by a boot LU enable configuration based on the boot LU switch configuration being set to a first codepoint, using a first boot LU of two candidate boot LUs based on the boot LU switch configuration being set to a second codepoint, or using a second boot LU of the two candidate boot LUs based on the boot LU switch configuration being set to a third codepoint. For example, as described above in connection with FIG. 7, a UFS device may use a boot LU indicated by a boot LU enable configuration (e.g., bBootLunEn) when the boot LU switch configuration (e.g., BootLUSwitch) is set to a first codepoint (e.g., codepoint 00h), the UFS device may use a first boot LU (e.g., boot LU A) of two candidate boot LUs when the boot LU switch configuration is set to a second codepoint (e.g., codepoint 01h), and/or the UFS device may use a second boot LU (e.g., boot LU B) of the two candidate boot LUs when the boot LU switch configuration is set to a third codepoint (e.g., codepoint 02h), among other examples.

Although FIG. 10 shows example blocks of a method 1000, in some implementations, the method 1000 may include additional blocks, fewer blocks, different blocks, or differently arranged blocks than those depicted in FIG. 10. Additionally, or alternatively, two or more of the blocks of the method 1000 may be performed in parallel. The method 1000 is an example of one method that may be performed by one or more devices described herein. These one or more devices may perform or may be configured to perform one or more other methods based on operations described herein.

In some implementations, a method includes receiving, by a memory system, a request to access one of a boot LU switch configuration associated with the memory system or a boot LU write protection configuration associated with the memory system, wherein the one of the boot LU switch configuration or the boot LU write protection configuration is protected by an authentication-key-protected portion of the memory system; determining, by the memory system, whether the request is authenticated based on at least one of an authentication key or a MAC associated with the request; and one of: allowing, by the memory system, the request to access the one of the boot LU switch configuration or the boot LU write protection configuration based on determining that the request is authenticated, or denying, by the memory system, the request to access the one of the boot LU switch configuration or the boot LU write protection configuration based on determining that the request is not authenticated.

In some implementations, a memory system includes one or more components configured to: receive a request to access one of a boot LU switch configuration associated with the memory system or a boot LU write protection configuration associated with the memory system, wherein the one of the boot LU switch configuration or the boot LU write protection configuration is protected by an authentication-key-protected portion of the memory system; determine whether the request is authenticated based on at least one of an authentication key or a MAC associated with the request; and one of: allow the request to access the one of the boot LU switch configuration or the boot LU write protection configuration based on determining that the request is authenticated, or deny the request to access the one of the boot LU switch configuration or the boot LU write protection configuration based on determining that the request is not authenticated.

In some implementations, a UFS compliant device includes one or more components configured to: receive a request to access one of a boot LU switch configuration associated with the UFS compliant device or a boot LU write protection configuration associated with the UFS compliant device, wherein the one of the boot LU switch configuration or the boot LU write protection configuration is protected by an RPMB of the UFS compliant device; determine whether the request is authenticated based on at least one of an authentication key or a MAC associated with the request; and one of: allow the request to access the one of the boot LU switch configuration or the boot LU write protection configuration based on determining that the request is authenticated, or deny the request to access the one of the boot LU switch configuration or the boot LU write protection configuration based on determining that the request is not authenticated.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the terms “substantially” and “approximately” mean “within reasonable tolerances of manufacturing and measurement.”

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a memory system, a request to access one of a boot logical unit (LU) switch configuration associated with the memory system or a boot LU write protection configuration associated with the memory system,
wherein the one of the boot LU switch configuration or the boot LU write protection configuration is protected by an authentication-key-protected portion of the memory system;
determining, by the memory system, whether the request is authenticated based on at least one of an authentication key or a message authentication code (MAC) associated with the request; and
one of:
allowing, by the memory system, the request to access the one of the boot LU switch configuration or the boot LU write protection configuration based on determining that the request is authenticated, or
denying, by the memory system, the request to access the one of the boot LU switch configuration or the boot LU write protection configuration based on determining that the request is not authenticated.

2. The method of claim 1, wherein the authentication-key-protected portion of the memory system is associated with a replay-protected memory block (RPMB) of the memory system.

3. The method of claim 2, wherein the one of the boot LU switch configuration or the boot LU write protection configuration is the boot LU write protection configuration, and
wherein the boot LU write protection configuration is associated with a secure write protect configuration block associated with region 0 of the RPMB.

4. The method of claim 3, wherein the secure write protect configuration block indicates that one of:
a boot LU is not write-protected,
the boot LU is power-on write-protected, or
the boot LU is permanently write-protected.

5. The method of claim 2, wherein the one of the boot LU switch configuration or the boot LU write protection configuration is the boot LU switch configuration, and
wherein the boot LU switch configuration is associated with a secure configuration protect (SCP) block associated with region 0 of the RPMB.

6. The method of claim 5, wherein the SCP block indicates that a boot LU active at power-on of the memory system is one of:
a boot LU indicated by a boot LU enable configuration, or
a selected boot LU of two candidate boot LUs.

7. The method of claim 5, further comprising receiving, by the memory system from a host system, at least one of:
a command associated with an SCP block write request corresponding to the boot LU switch configuration,
a command associated with an SCP block read request corresponding to the boot LU switch configuration,
a command associated with an SCP block write response corresponding to the boot LU switch configuration, or
a command associated with an SCP block read response corresponding to the boot LU switch configuration.

8. The method of claim 1, wherein the one of the boot LU switch configuration or the boot LU write protection configuration is the boot LU switch configuration, and
wherein the method further comprises performing, by the memory system, one of:
using a boot LU indicated by a boot LU enable configuration based on the boot LU switch configuration being set to a first codepoint;
using a first boot LU of two candidate boot LUs based on the boot LU switch configuration being set to a second codepoint; or
using a second boot LU of the two candidate boot LUs based on the boot LU switch configuration being set to a third codepoint.

9. A memory system, comprising:
one or more components configured to:
receive a request to access one of a boot logical unit (LU) switch configuration associated with the memory system or a boot LU write protection configuration associated with the memory system,
wherein the one of the boot LU switch configuration or the boot LU write protection configuration is protected by an authentication-key-protected portion of the memory system;
determine whether the request is authenticated based on at least one of an authentication key or a message authentication code (MAC) associated with the request; and
one of:
allow the request to access the one of the boot LU switch configuration or the boot LU write protection configuration based on determining that the request is authenticated, or
deny the request to access the one of the boot LU switch configuration or the boot LU write protection configuration based on determining that the request is not authenticated.

10. The memory system of claim 9, wherein the authentication-key-protected portion of the memory system is associated with a replay-protected memory block (RPMB) of the memory system.

11. The memory system of claim 10, wherein the one of the boot LU switch configuration or the boot LU write protection configuration is the boot LU write protection configuration, and
wherein the boot LU write protection configuration is associated with a secure write protect configuration block associated with region 0 of the RPMB.

12. The memory system of claim 11, wherein the secure write protect configuration block indicates that one of:
a boot LU is not write-protected,
the boot LU is power-on write-protected, or
the boot LU is permanently write-protected.

13. The memory system of claim 10, wherein the one of the boot LU switch configuration or the boot LU write protection configuration is the boot LU switch configuration, and
wherein the boot LU switch configuration is associated with a secure configuration protect (SCP) block associated with region 0 of the RPMB.

14. The memory system of claim 13, wherein the SCP block indicates that a boot LU active at power-on of the memory system is one of:
a boot LU indicated by a boot LU enable configuration, or
a selected boot LU of two candidate boot LUs.

15. The memory system of claim 13, wherein the one or more components are further configured to receive, from a host system, at least one of:
a command associated with an SCP block write request corresponding to the boot LU switch configuration,
a command associated with an SCP block read request corresponding to the boot LU switch configuration,
a command associated with an SCP block write response corresponding to the boot LU switch configuration, or
a command associated with an SCP block read response corresponding to the boot LU switch configuration.

16. The memory system of claim 9, wherein the one of the boot LU switch configuration or the boot LU write protection configuration is the boot LU switch configuration, and
wherein the one or more components are further configured to perform one of:
use a boot LU indicated by a boot LU enable configuration based on the boot LU switch configuration being set to a first codepoint;
use a first boot LU of two candidate boot LUs based on the boot LU switch configuration being set to a second codepoint; or
use a second boot LU of the two candidate boot LUs based on the boot LU switch configuration being set to a third codepoint.

17. A universal flash storage (UFS) compliant device, comprising:
one or more components configured to:
receive a request to access one of a boot logical unit (LU) switch configuration associated with the UFS compliant device or a boot LU write protection configuration associated with the UFS compliant device,
wherein the one of the boot LU switch configuration or the boot LU write protection configuration is protected by a replay-protected memory block (RPMB) of the UFS compliant device;
determine whether the request is authenticated based on at least one of an authentication key or a message authentication code (MAC) associated with the request; and
one of:
allow the request to access the one of the boot LU switch configuration or the boot LU write protection configuration based on determining that the request is authenticated, or
deny the request to access the one of the boot LU switch configuration or the boot LU write protection configuration based on determining that the request is not authenticated.

18. The UFS compliant device of claim 17, wherein the one of the boot LU switch configuration or the boot LU write protection configuration is the boot LU write protection configuration, and
wherein the boot LU write protection configuration is associated with a secure write protect configuration block associated with region 0 of the RPMB.

19. The UFS compliant device of claim 18, wherein the secure write protect configuration block indicates one of:
a boot LU is not write-protected,
the boot LU is power-on write-protected, or
the boot LU is permanently write-protected.

20. The UFS compliant device of claim 17, wherein the one of the boot LU switch configuration or the boot LU write protection configuration is the boot LU switch configuration, and
wherein the boot LU switch configuration is associated with a secure configuration protect (SCP) block associated with region 0 of the RPMB.

21. The UFS compliant device of claim 20, wherein the SCP block indicates that a boot LU active at power-on of the UFS compliant device is one of:
a boot LU indicated by a boot LU enable configuration, or
a selected boot LU of two candidate boot LUs.

22. The UFS compliant device of claim 20, wherein the one or more components are further configured to receive, from a UFS host, at least one of:
a command associated with an SCP block write request corresponding to the boot LU switch configuration,
a command associated with an SCP block read request corresponding to the boot LU switch configuration,
a command associated with an SCP block write response corresponding to the boot LU switch configuration, or
a command associated with an SCP block read response corresponding to the boot LU switch configuration.

23. The UFS compliant device of claim 17, wherein the one of the boot LU switch configuration or the boot LU write protection configuration is the boot LU switch configuration, and
wherein the one or more components are further configured to perform one of:
use a boot LU indicated by a boot LU enable configuration based on the boot LU switch configuration being set to a first codepoint;
use a first boot LU of two candidate boot LUs based on the boot LU switch configuration being set to a second codepoint; or
use a second boot LU of the two candidate boot LUs based on the boot LU switch configuration being set to a third codepoint.
